(19) United States
(12) Patent Application Publication
(10) Pub. No.: US 2020/0348183 A1
(43) Pub. Date: Nov. 5, 2020

(54) SYSTEM AND METHOD FOR NON-CONTACT WETNESS DETECTION USING THERMAL SENSING

(71) Applicant: SMARTCLEAN TECHNOLOGIES, PTE. LTD., Singapore (SG)

(72) Inventors: Lav AGARWAL, Singapore (SG); Arish SHAREEF, Singapore (SG); Abhishek MISHRA, Singapore (SG); Sarah REDDY, Singapore (SG)

(21) Appl. No.: 16/957,411

(22) PCT Filed: Dec. 28, 2018
(86) PCT No.: PCT/SG2018/050633

§ 371 Date: Jun. 24, 2020

(30) Foreign Application Priority Data
Jan. 4, 2018 (SG) 10201800109W

(51) Int. Cl. G01J 5/12; G06K 9/00; G06K 9/46; G06K 9/62

(52) U.S. Cl. CPC G01J 5/12; G06K 9/00771; G01J 2005/0077; G06K 9/6261; G06K 9/6201; G06K 9/46

(57) ABSTRACT

Embodiments include a system and method for detecting and identifying wetness in a washroom or other facility using thermal sensing. A thermal sensor collects data on surface temperatures in an area such as a washroom. The data is analyzed to identify differences and/or deviations from baseline temperatures. Wetness can be identified based on the differences and/or deviations. The data can be further analyzed to identify the source and/or type of wetness. A cleaner or stakeholder can be contacted for cleaning and/or maintenance if wetness levels exceed a threshold level.

### TECHNICAL FIELD

The invention relates to cleaning and maintenance, and more specifically, to a system and method of detecting and identifying wetness in a washroom or other facility using thermal sensing and tracking the wetness over time.

### BACKGROUND

Public or commercial washrooms typically include appliances such as toilets, urinals and sinks with faucets. Regular and systematic cleaning and maintenance is essential but can be time consuming and expensive. In a conventional approach, a facility employee will make periodic visits to a washroom for inspection and/or cleaning. A checklist may be used to ensure that a given set of tasks are complete. It can include a list of scheduled times to return for future inspections and service. If a supervisor or manager determines that a washroom is inadequately maintained, he/she can increase the frequency of cleaning operations. However, this assumes that more frequent cleaning operations will lead to better cleanliness. This assumption can lead to an inefficient use of resources.

A common problem is the accumulation of water or other liquids on floors and counters of restroom facilities. Wet floors are commonly found in washrooms due to water spill from sources for example basins. Accordingly, wetness is an important consideration when evaluating washroom cleanliness. During typical use, a visitor may splash water from a wash basin onto the nearby counter top as well as the floor. Similarly, liquids may accumulate around toilets. Thus, cleaning and maintenance can be important when levels of water and/or liquid reach a threshold. Failure to identify wetness can also lead to premises liability as it is a common cause of slip and fall accidents.

Wetness can also be caused by an appliance failure, leaky pipe/valve or accident. A leaky valve, sink or toilet overflow can lead to wetness or flooding. A clogged pipe can also cause a sink or toilet to continuously fill and overflow. In these situations, cleaning and maintenance can be imperative for safety and to mitigate or prevent property damage. Accordingly, a system and method of automatically detecting wetness within a facility is needed to improve cleaning methods and efficiency as well as to reduce/prevent water damage and premises liability.

Efforts have been made to detect wetness by wetness sensors. If a sufficient amount of water is present, a valve can be closed to prevent further spillage. Typical wetness detection is performed by using an electrical patch on the floor whose conductive/capacitive properties are affected when in contact with fluid, thereby resulting in detection of fluid spills. Such sensors are packaged as long wires with one end for detecting fluids and the other for computation and communications.

U.S. Pat. No. 5,091,715 describes a lead detection and alarm system. A housing has a flat bottom surface and support feet comprising electrodes of the alarm. The feet elevate the bottom of the housing above the floor such that the bottom of each support foot is in direct contact with the floor. The bottom of each support foot comprises a separate electrode of the alarm system. While the housing may be effective at detecting water, the system relies on water to contact the electrodes and activate system. Further, it may be impractical to place the housing on a floor of a washroom. Moreover, multiple housings may be necessary to cover a large area.

U.S. Pat. No. 6,812,846 presents an alternative to the use of an electrical patch. It describes a spill detector that uses optical image-processing hardware and software to detect spilled liquid. A camera collects a series of still images or video in a market or warehouse. Individual frames are compared to distinguish objects from spilled liquid. If a spill is detected with a certain degree of probability, the system can generate a notification. While the invention may be effective for use in detecting spills, it may not be practical for other uses. Using light cameras in washrooms is generally undesirable for privacy concerns and may be forbidden in some jurisdictions.

Similarly, U.S. Pat. No. 7,688,215 describes a system for detecting moisture in residential and commercial structures such as in the walls or roof of a building. Each sensor is a flat adhesive tape of a substrate of dielectric, hydrophobic material. While the substrate may be easier to place in an area such as a washroom, water must contact the material to activate it. The system requires a series of wires on the floor area near possible sources of spill such as urinals, wash basins, and/or others. The system can be tedious to install and invasive to the facility's operations due to the infrastructure. Further, false alerts can be raised as the point of contact of wires is small in area.

While these inventions present approaches toward wetness monitoring, they have shortcomings. Electrical patches require physical contact with water. They also lack sensitivity as there must be sufficient water in contact with electrodes for detection. Further, the detectors must be thoroughly dried or replaced after water detection. Light cameras can also lack sensitivity and are generally undesirable due to privacy concerns. Accordingly, there is a need for an improved system and method for wetness monitoring.

The improved system should overcome the limitations of conventional approaches. It should detect wetness without contacting surfaces. It should also utilize Internet of Things (“IoT”) enabled integrated devices for constant monitoring of a surface area to detect the presence of fluid (water, urine, and/or others) with high sensitivity.

### SUMMARY OF THE INVENTION

Detecting wet counter tops and floors is an important task for maintaining overall cleanliness. The invention recognizes that there is a need for an improved system and method for monitoring wetness on a floor or counter tops of a facility such as a washroom, gathering area, inside of a vehicle, etc.

Thermal imaging can show wetness by utilizing the specific heat capacity of water, ambient infrastructure, materials and/or others. The system uses thermal imaging for detecting the presence and source of leakages such as spills, overflows as well as leakage from pipes concealed within walls or floors. One or more sensors record a series of thermal images of an area. The images can be compared with one another to detect temperature differences that can be attributed to wetness. The system can also monitor and track the amount of wetness present as it increases or dissipates overt time.

The following summary is provided to facilitate an understanding of some of the innovative features unique to the disclosed embodiments and is not intended to be a full description. A full appreciation of the various aspects of the embodiments disclosed herein can be gained by taking into consideration the entire specification, claims, drawings and abstract as a whole.

Embodiments include a system for detecting wetness on a surface comprised of (a) a sensor for detecting surface temperatures, (b) a database for storing surface temperature data, (c) an interface and (d) a processor. The processor can identify baseline temperatures of surfaces. Wetness can be identified as aberrations from baseline temperatures of surfaces. Cleaning and/or maintenance can be scheduled when wetness on the surface reaches or exceeds a threshold level. The processor can also identify fluid (i.e. the composition of the wetness) and/or source of the wetness based on its thermal characteristics.

The sensor can be a thermal sensor or thermopile array that records thermal images of the surfaces including the floor, shelves, table tops, sinks, panels, appliance tops, counter tops, etc. The sensor can use sampling rates that are time based and/or event based. Sampling rates can also adjusted based on patterns of facility use. The sensor can be comprised of a sensing element, a data interchange unit, a memory unit and a fluid detection unit. The processor can be comprised of a data capture module, a fluid detection module and a belief update module. The system can be used in a facility such as a washroom, kitchen, lounge, dining area, conference center, auditorium, gym, recreational area, market, shop, elevator/lift, interior of a vehicle or other gathering area.

Embodiments also include a computer implemented method for detecting wetness on a surface comprising of steps of (a) collecting data on surface temperatures using at least one sensor, (b) identifying baseline surface temperatures, (c) identifying wetness as aberrations of baseline surface temperatures, (d) comparing data on wetness from at least two time points to improve belief and (e) alerting one or more workers and/or stakeholders when wetness on the surface reaches or exceeds a threshold level. The method can account for variables including heat from the environment such as sunlight and wind, human body heat, heat from electrical sources and/or heat from light sources.

Embodiments further include a computer implemented method for identifying fluid in wetness (i.e. the composition of the wetness) on a floor or surface comprising of steps of (a) collecting data on thermal characteristics of wetness using at least one sensor, (b) compiling a database of thermal signatures of fluids based on thermal properties exhibited on one or more surfaces, (c) identifying fluids (e.g. water, sweat, oil, paint, vomit, urine, blood and/or a beverage) by comparing thermal signatures of known fluids in the database, (d) comparing detection results from at least two time points to improve belief and (e) alerting one or more workers and/or stakeholders with information on the fluid, including its identity. An algorithm can be used in identifying fluids by comparing thermal signatures of known fluids in a database. The algorithm can use frequency domain techniques, time domain techniques or a hybrid approach.

The method can also include a step of learning and maintaining an estimate of trends and/or a step of maintaining a historical record of data. An autonomous or self-cleaning system (e.g. robotic cleaner) can be activated based on an identified fluid. The method can further include a step of segregating a field of view of the sensor into contiguous areas of thermal properties using a continuity criterion of baseline temperatures.

While the invention is described for use in washroom facilities, it has other applications. It is useful in other facilities that require observation and periodic cleaning and/or maintenance. For example, it can be used to improve efficiency and the effectiveness of cleaning and maintenance services in kitchens, cafeterias, lounges, conference rooms, transit centers, theme parks, shops/stores, warehouses, restaurants/cafes, lifts/elevators and other gathering areas. It can also be used in vehicles such as automobiles, buses, trains and aircraft. Further, the invention can be modified to include additional sensors and/or remove one or more of those described herein.

### Introduction

A first aspect of the invention is a system for non-contact wetness detection.

A second aspect of the invention is a system of sensors and devices for a washroom that detect wetness using thermal imaging.

A third aspect of the invention is a method of detecting the accumulation or decrease in wetness in an area over time.

A fourth aspect of the invention is an IoT sensor network design and associated cloud and local system architecture for a water detection and an alerting system.

A fifth aspect of the invention is an alerting module that sends alerts to endpoints for cleaning operations when wetness reaches a threshold.

A sixth aspect of the invention is a method of detecting water or fluid spillage from a leaky valve, pipe, fixture, toilet or basin using thermal sensors.

A seventh aspect of the invention is a method of detecting wetness that includes collecting data on surface temperatures and comparing the data from two or more time points to identify and/or monitor wetness.

An eighth aspect of the invention is a method of detecting wetness that accounts for variables such as changes in ambient temperature and heat from objects (e.g. electricity, sunlight and people) in an environment.

A ninth aspect of the invention is an alerting module that sends a decision to an endpoint under particular conditions.

A tenth aspect of the invention is a method of identifying fluid in wetness by comparing the thermal signature of a fluid to those of known fluids collected in a database.

A tenth aspect of the invention is a method of wetness detection that includes a step of activating one or more autonomous or self-cleaning systems based when wetness above a threshold is detected.

### BRIEF DESCRIPTION OF FIGURES

The drawings described herein are for illustrative purposes only of selected embodiments and not all possible implementations, and are not intended to limit the scope of the present disclosure.

The summary above, as well as the following detailed description of illustrative embodiments, is better understood when read in conjunction with the appended drawings. For the purpose of illustrating the disclosure, exemplary constructions of the disclosure are shown in the drawings. However, the disclosure is not limited to specific methods and instrumentalities disclosed herein. Moreover, the drawings are not to scale.

FIG. 1A depicts the system within an enclosure such as a washroom comprising different types of fluid spills.

FIG. 1B depicts the system within an enclosure with multiple small fluid spills.

FIG. 2A depicts distinct zones within an enclosure as evenly distributed areas that are monitored for the presence of fluid spills.

FIG. 2B depicts distinct zones within an enclosure that are monitored for the presence of fluid spills by a sensor.

FIG. 3A depicts the field of view of a sensor and the effects of height and angle of the area that is monitored for fluid spills.

FIG. 3B also depicts the field of view of a sensor and the effects of height and angle of the area that is monitored for fluid spills.

FIG. 4A depicts the main components of the wetness detection sensor including a memory, fluid detection module and wireless module for remote access and data interchange with the cloud.

FIG. 4B depicts an alternate design of a wetness detection sensor wherein the fluid detection module is located elsewhere (either on the cloud or on an edge computing device within the facility).

FIG. 5A depicts a system design wherein multiple sensors (within the same facility) communicate with a single gateway that relays data to the cloud platform.

FIG. 5B depicts a system design wherein wetness detection sensors are independently connected to the cloud platform.

FIG. 6 depicts a method of wetness detection as three processing blocks including a data capture module, a fluid detection module and a belief update module.

FIG. 7 depicts the process flow of the data capture module that updates a global buffer with sensor data based on a sampling rate that can be adjusted based on other data processing elements.

FIG. 8 depicts the process flow for the fluid detection module that consumes data from the global buffer and updates the constant belief update module.

FIG. 9 depicts the process flow of the belief update module that updates each pixel's belief and aggregates such belief values from multiple pixels according to an aggregation paradigm to determine the presence of various types of fluid spills.

FIG. 10 depicts the final module that aggregates multiple belief values from neighboring pixels and infers properties such as fluid type and spread area, along with other auxiliary parameters such as alerting conditions for downstream processing by the middleware.

FIG. 11 depicts the fluid type detection sub-module that takes sensor data readings across time and classifies the regions as a particular type of fluid (e.g. water, beverage, and/or others).

FIG. 12 depicts the process flow for spill-type detection module that infers the presence of various spill scenarios such as multiple small drops, big puddle or a combination. These parameters can be configured per sensor at any time by stakeholders.

FIG. 13 depicts the area threshold sub-module that assesses the area of coverage of spills detected by the sensor and provides an estimate of the equipment necessary to attend to the spill.

FIG. 14 depicts the similarity checking sub-module that infers if the last activation happened due to the same source and/or in the same area.

FIG. 15 depicts a dashboard view which provides a historical access to number of activations, spill types, their locations aggregated by time units of days or hours.

FIG. 16 depicts examples of various alerts generated by the middleware that can send out text based alerts to stakeholders about detections by multiple sensors installed within the facility.

FIG. 17 depicts a web or mobile based dashboard provided to stakeholders for facilitating configuration of sensor parameters during installation including zones descriptions and areas covered.

FIG. 18 depicts the provision of a device that can be used during the installation process to determine/visualize the field of view of a sensor so that the sensor can monitor the desired area/zones.

FIG. 19 depicts a dashboard view wherein multiple sensor parameters can be configured to modify operation of the firmware running on the sensors.

FIG. 20 depicts the wetness detection sensor installed in a smart washroom with other types of sensors that can detect air quality, traffic of people, and/or feedback from users.

### NUMERICAL REFERENCE FEATURES

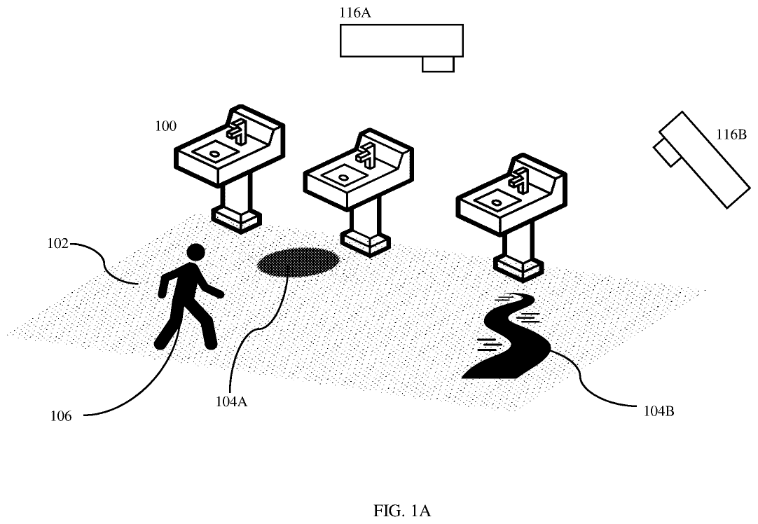

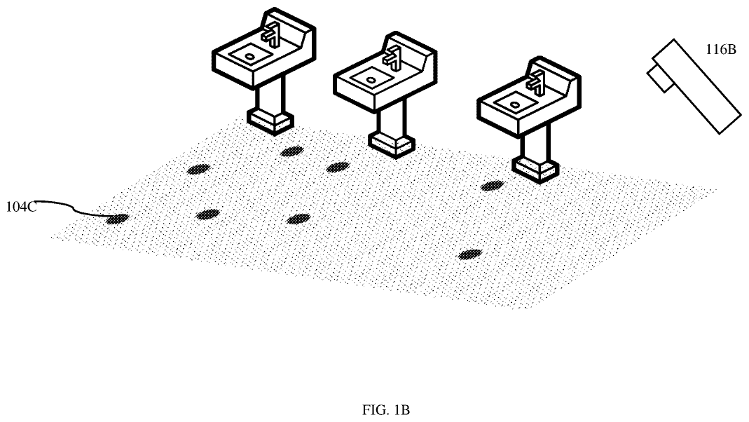

The following list of index numbers and associated features is intended for ease of reference to FIG. 1 through FIG. 20 and illustrative embodiments of the disclosure:
100—Washroom Basin
102—Washroom Floor
104A—Fluid Spill (caused by user)
104B—Fluid Spill (caused by leak)
104C—Fluid Spill (small)
106—Washroom Visitor
100—Wash Basin
110—Zone, Patch or Marked Area within a Grid
112—Processing Unit
114—Communication Unit
116—Thermal Sensor
116A—Thermal Sensor (ceiling mounted)
116B—Thermal Sensor (wall mounted)
124—Fluid Detection Unit (FDU)
126—Memory Unit
128A—Data Interchange Unit (with direct connection)
128B—Data interchange Unit (that transfers to a gateway or cloud)
130—Sensing Element
134—Gateway Module
138—Cloud
140—Data Interchange Link
292A—Fluid Spill (large)
292B—Fluid Spill (small)
292C—Fluid Spill (false positive)
370—Auxiliary Device for Sensor Placement
372—Visual Indicators of Auxiliary Device
390—People Counter
392—Consumer Feedback and Task Logging Device
394—Air Quality Monitor
396—Smart Washroom

### DETAILED DESCRIPTION OF THE INVENTION

### Definitions

Reference in this specification to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but not other embodiments/aspects. Embodiment and aspect can be in certain instances be used interchangeably.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Directional and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments in this specification and the appended claims, and are not necessarily intended to be construed as limiting.

As applicable, the terms “about” or “generally”, as used herein in the specification and appended claims, and unless otherwise indicated, means a margin of +/−20%. Also, as applicable, the term “substantially” as used herein in the specification and appended claims, unless otherwise indicated, means a margin of +/−10%. It is to be appreciated that not all uses of the above terms are quantifiable such that the referenced ranges can be applied.

The term “access key” refers to are means for preliminary device authentication and for implementing data rate controls. A device access key can be shared by more than one device based on some grouping criteria.

The term “analog” or “analog signal” refers to any continuous signal for which the time varying feature (variable) of the signal is a representation of some other time varying quantity (i.e., analogous to another time varying signal).

The term “anomaly detection” or “outlier detection” refers to the identification of rare items, events or observations which raise suspicions by differing significantly from the majority (or expected) data. Typically the anomalous item(s) will indicate to some kind of problem and/or mess at a washroom facility.

The term “application programing interface” or “API” refers to a set of subroutine definitions, protocols and tools for building software. In general terms, it is a set of clearly defined methods of communication between various components.

The term “cloud” or “cloud computing” refers to an information technology (IT) paradigm that enables ubiquitous access to shared pools of configurable system resources and higher-level services that can be rapidly provisioned with minimal management effort, often over the Internet.

The term “controller” refers to a comparative device that receives an input signal from a measured process variable, compares this value with that of a predetermined control point value (set point), and determines the appropriate amount of output signal required by the final control element to provide corrective action within a control loop. An electronic controller uses electrical signals and digital algorithms to perform its receptive, comparative and corrective functions.

The term “Controller Area Network,” “CAN” or “CAN bus” refers to a vehicle bus standard designed to allow microcontrollers and devices to communicate with each other in applications without a host computer.

The term “ecosystem” refers to product platforms defined by core components and complemented by applications in a periphery.

A “gateway device” refers to a hardware device that acts as a “gate” between two networks. It can be a router, firewall, server, or other device that enables traffic to flow in and out of the network.

A “hash function” refers to any function that can be used to map data of arbitrary size to data of a fixed size. The values returned by a hash function are called hash values, hash codes, digests, or simply hashes.

The term “Internet of Things” or “IoT” refers to a network of physical devices, vehicles, home appliances, and other items embedded with electronics, software, sensors, actuators, and connectivity which enables them to connect and exchange data, creating opportunities for more direct integration of the physical world into computer-based systems, resulting in efficiency improvements, economic benefits, and reduced human exertions.

The term “installation location” refers to any area where a single device or a group of sensing devices are installed to monitor the requirement for cleaning. The system can tag such locations and associate other parameters such as stakeholder alerts, frequency of alerts, etc. Each installation location can be represented by a unique identifier and a user-friendly display name that denotes its physical location.

The term “near-field communication” or “NFC” refers to a set of communication protocols that enable two electronic devices, one of which is usually a portable device such as a smartphone, to establish communication by bringing them within a certain distance of each other (e.g. 4 cm/1.6 inches).

The term “radiometric detection” or “radiometric calculation” refers to a precise measurement of electromagnetic radiation, including visible light. Radiometric techniques in optics characterize the distribution of the radiation's power in space.

The term “stakeholder” refers to any person related to the facility operations. This can include cleaners, attendants, supervisors, managers and/or others.

The term “thermal characteristic” refers to properties exhibited by fluids in contact with a surface that can be detected/observed with a thermal sensor or thermopile array (e.g. due to evaporative cooling or other thermodynamic properties).

The term “thermal sensor” or “thermopile” refers to an electronic device that converts thermal energy into electrical energy. It is composed of several thermocouples connected usually in series and sometimes in parallel. Thermopiles can provide an output in response to temperature as part of a temperature measuring device. The output of a thermopile is usually in the range of tens or hundreds of millivolts

The term “thermal signature” refers to characteristics unique to a particular fluid in contact with a surface that can be detected/observed with a thermal sensor or thermopile array (e.g. “tracked features).

Other technical terms used herein have their ordinary meaning in the art that they are used, as exemplified by a variety of technical dictionaries. The particular values and configurations discussed in these non-limiting examples can be varied and are cited merely to illustrate at least one embodiment and are not intended to limit the scope thereof.

### Description of Preferred Embodiments

An important aspect of facility management is to ensure cleanliness of various areas including washrooms, pantry areas, corridors, lobbies, cafeterias, etc. This is particularly important in public facilities, such as malls, airports, hospitals, and cafeterias. In conventional practice, the desired frequency of cleaning operations is varied in tenders quoted to cleaning companies. However, this approach assumes that more frequent cleaning operations correlates to better cleanliness. Further, it assumes that the cleaning tasks are being effectively performed in the absence of a supervisor.

The invention includes an IoT integrated system and associated methods for enabling automated wetness detection on a surface area within a facility such as a washroom. In preferred embodiments, a downward facing sensor is installed on the ceiling of an area to be monitored for wetness. This sensor can estimate the absolute temperature of each pixel's field of view (i.e. radiometric analysis). A pixel resolution of 50×50 can be preferred for the system to perform effectively.

Thermal imaging provides data about a scene based on the temperature of various areas. This is different from color-based imaging approaches where each pixel in the imager responds to the electromagnetic wavelengths of visible light spectrum reflected/emitted by objects. Detection of fluid using color-based approaches is a complex task because fluids such as water are transparent and do not provide any inherent discriminative information for algorithms to operate on. As a result, system and methods that use color cameras can exhibit high false positive and true negative rates. However, objects have varying thermal signatures that exhibit features which can be utilized by algorithms and systems to accurately discriminate them.

The system uses one or more sensors to record a series of images of an area. The images can be compared with one another to detect temperature differences. Areas with aberrations in temperature from baselines can be identified as wetness. The system can also monitor and track the amount of wetness present as it increases or dissipates over time.

The system can sample images at a particular frequency (e.g. 1 minute, 2 minutes, 5 minutes, or 10 minutes) to develop a baseline temperature profile of a floor area (i.e. temperature profile without wetness). This baseline represents the ground truth where no anomaly (wetness) has been detected. Ambient conditions (e.g. temperature, humidity, time of day, and/or others) can be considered in determining the baseline. The system can further aggregate neighboring pixel regions to form a ground truth belief about baselines across the field of view of the sensor.

The system can divide the detection process into two steps: feature tracking and feature classification. These steps can be performed consecutively or simultaneously. In preferred embodiments, the two steps are performed simultaneously for quicker detection within a threshold period of time.

A tracking module can implement methods to allow segregation of near-circular or irregular shaped blobs on the floor having distinct temperature difference with respect to the floor. The module can capture multiple images at intervals to validate the presence of such blobs across a time duration, and thereafter send a trigger to the detection module for initialization.

Features that are tracked can include the cooling rate/profile of blobs/regions or their area. These features are necessarily tracked by the system across a certain time duration for creating a signature. Appropriate signature matching is performed to determine if the tracked regions are indeed fluid or not. This matching can be performed in both time or frequency domains through use of hash functions.

Upon detection of fluid on a surface, the system can send an alert to the cloud server that maintains the architecture and logs the time for future action. The system can also form a part of a smart building where IoT connected sensors detect and help prevent or alert various faults that can happen within the facility. The system can be an important part of a larger sensor network within the facility for facilitating facility management with respect to cleanliness.

### Placement of Thermal Sensor

FIG. 1A depicts the system in an enclosed area such as a washroom facility with different types of fluid spills. A thermal sensor 116A is installed on or near the ceiling which is typically around 10 to 12 feet above the floor 102. The sensor is downward facing so that it can have multiple elements in its field of view such as basins (100A, 100B, 100C) driers, and/or other devices. Additionally, dynamic elements such as moving persons 106 can enter/exit the area being monitored. These static and dynamic elements can be visible to the sensor 116 depending on its field of view (FoV). The sensor can be passive in nature, that is, it utilizes the heat in the environment to generate images without using an active source of electromagnetic energy (e.g. infra-red).

In a typical washroom, various types of spills can occur (104A, 104B). A spill can result from leakage from basins or beverages carried by people 104A. This type of spill can be correlated with use of the washroom and behavior of the users. This splash is typical in areas where visitors wash hands and water spills due to droplets falling on the area. Over time, droplets can cause an area to be sufficiently wet such that the sensor detects wetness and sends an alert for appropriate action. A spill can also result from faults in pipes, urinals, or other conduit carrying fluid 104B.

Additional sensors can be installed on the side walls of the washroom 116B to monitor the area. Sensors on the walls can be angled (e.g. 30-60 degrees) for maximum views. The system can use the sensor(s) to detect the presence of spills within a duration of time.

FIG. 1B depicts the system in an enclosed area such as a washroom facility with multiple small fluid spills 104C. A thermal sensor 116B is installed on a wall of the washroom. In this orientation, the sensor's view and perception of the scene is a perspective of objects and areas being monitored for wetness. Advantages of this wall-mounted sensors include (a) increased coverage area for monitoring resulting from oblique field of view, (b) more accurate sensor readings resulting from closer height of installation with respect to the area being monitored and (c) relatively easier removal of false positive sources such as humans and basins due to their projection on the sensor's focal plane. Disadvantages include (a) the possibility of sensor damage as they are closer to human reach, (b) increasing distance of areas being monitored due to oblique installation thereby affecting accuracy per pixel instead of the entire module as a whole, and (c) installation challenges resulting from wiring and sensor placement.

In areas such as lifts, lobbies, malls and hospitals, the preferred method of installation can be overhead. In enclosed areas such as washrooms, cubicles and vanity tops where more specific monitoring is required, the preferred installation can be on one or more walls. Moreover, to cover a large area, multiple sensors can be installed on both the ceiling and walls.

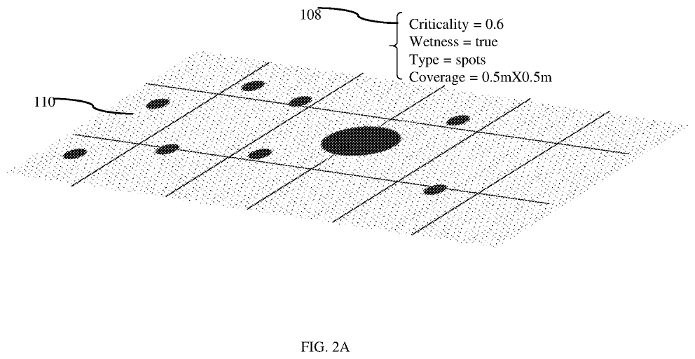

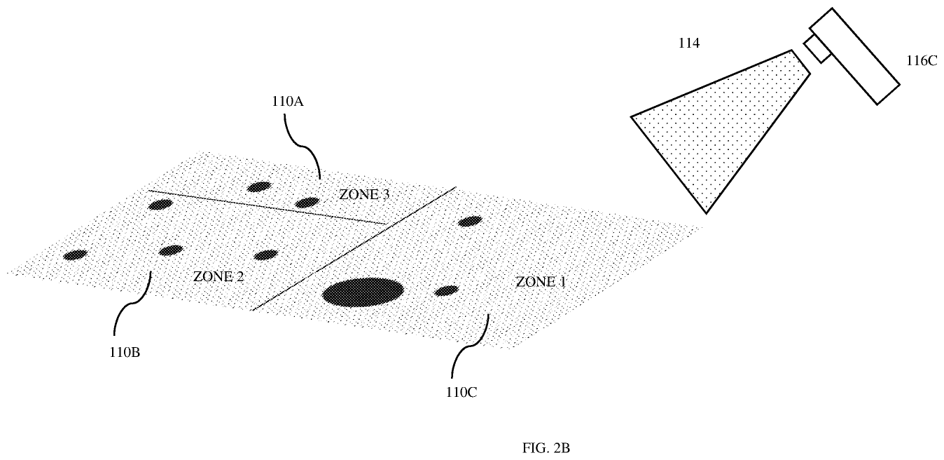

The monitored area (e.g. washroom) can be divided into a grid so that individual patches 110 can be characterized as depicted in FIG. 2A. This partitioning can be performed as non-overlapping regions of different sizes (e.g. 20 pixels×20 pixels, 30 pixels×30 pixels, etc.). The length of the partition region length can be calculated based on the height and method of sensor placement. The overall distance of various partitions from the sensor can affect the coverage area of each pixel.

By defining regions of the monitored area, the sensor can collect data to estimate the amount of fluid spill in the area and the specific locations on the monitored area where fluid spills are detected. This can lead to more specific alerts about spill types and their locations that can be relayed to stakeholders.

Methods can be implemented to estimate parameters 108 such as the extent of coverage of wetness and the appropriate type of cleaning resources and equipment. The system can also generate a criticality parameter based on the factors mentioned such as extent of spill—how many partitions does the spill affect, type of spill—multiple small spots, single large spill, and/or others. The criticality calculation may in part be configurable by the facility stakeholders to allow subjective estimates of what constitutes a dirty environment versus what type of wetness scenarios can be ignored because that they dry up automatically over time or do not require immediate attention.

In embodiments where the sensor has been installed on a wall (i.e. positioned sideways), the partitions can be varied dynamically in their size such as increasing area from farthest end to closest end of the sensor's field of view. An oblique installation introduces a perspective transformation to the data captured and can be accounted for during calculations to allow accurate measurements of spill sizes and their spread within the monitored area. The appropriate data transformations can be carried out within the sensor or on the edge gateway/cloud. In preferred embodiments, a transformation matrix is estimated by associated software post installation that is used by further calculations. This transformation matrix necessarily transforms the oblique (perspective) view of the sensor to that of a planar rectangular view as if the sensor were installed on the top of installation location.

FIG. 2B depicts a of perspective view 114 of transformed data for an obliquely installed sensor 1160. The area is partitioned such that data from the sensor is collected from multiple zones (110A, 110B, 110C). These zones can be defined by stakeholders based on some physical manifestation of these locations. For example, zone 1 (110C) depicts the common floor area near wash basins inside a washroom. Zone 2 (110B) can represent an area near cubicles and zone 3 (110A) can represent vanity tops of basin area within a washroom. This scenario can be used when a single sensor overlooks multiple types of areas within the installation location.

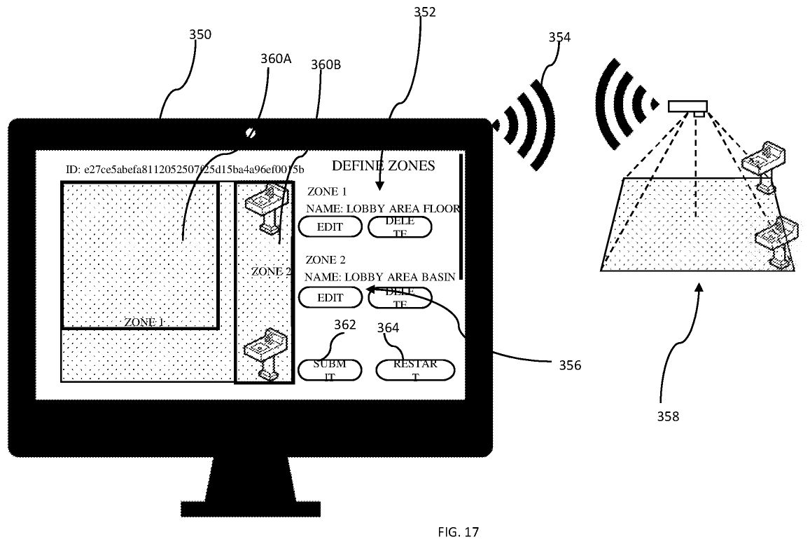

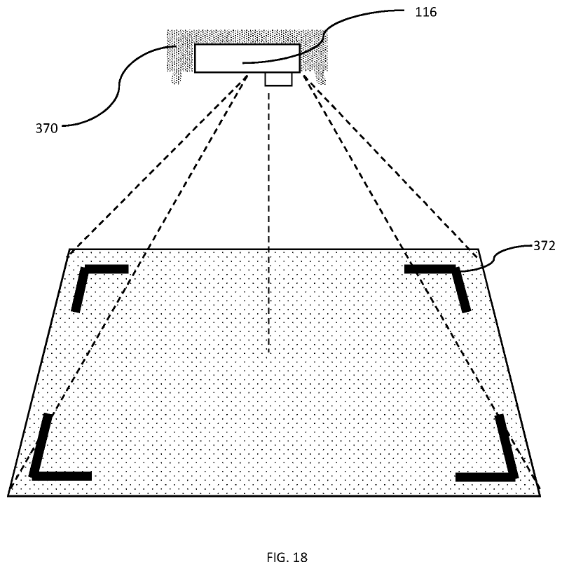

Appropriate methods to detect wetness in these zones can be implemented separately from one another. This kind of partitioning is similar to a scenario where more than one sensor is installed to detect wetness in multiple areas. Moreover, the detection process can be streamlined to be more specific the kind of area being monitored. For example, a certain amount of wetness on a vanity top can be accepted to avoid false positives. Wetness near cubicles or urinal areas can result from multiple spots that form over time from human waste and contribute to the uncleanliness of the environment. This approach saves the cost of installing multiple sensors to monitor different types of physical areas by performing the data segregation internally. In preferred embodiments, these zones always exist on sensor installation and are defined by the respective stakeholders during installation through auxiliary software and hardware as described further in FIG. 17 and FIG. 18. The sensing parameters for each zone can be modified independently based on the fact that different types of spill scenarios are more common in different areas, the average amount of time spent by people in that region.

In preferred embodiments, the zones are rectangular thereby requiring only two parameters for their definition, top left and bottom right. Further methods can be defined to allow definition of areas to ignore by defining circular or rectangular areas within the zones. This can be, for example, when the sensor is monitoring the vanity top or cubicles in a washroom for wetness. The presence of basins and urinals can be an intermittent source of wetness and may be ignored. The sensor can utilize area definition based methods to ignore the static regions from analysis. For example, basin areas are usually circular to the sensor's data and definition of their centers and radii is sufficient to calculate areas within a zone that must not be taken into account during wetness detection process. This is based on the assumption that post sensor installation, the static elements within the sensor's field of view do not change for a long time duration. Alternatively, the associated software may ignore such static areas through feature based methods described in further sections.

The partitioning scheme depicted in FIG. 2A can be then be further applied within the zones defined for greater control over location of spills within the zones. This kind of hybrid partitioning scheme can generate alerts, for example, from a vanity top area specifying the basin number that has most fluid present or in case of cubicles, the specific cubicle numbers where the wetness is present.

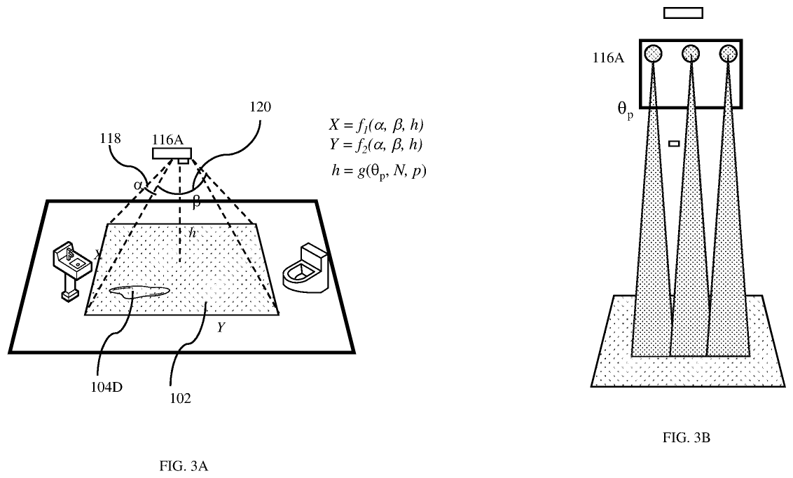

FIG. 3A depicts the field of view (FoV) of a sensor 116A installed on a false ceiling. A typical wetness detection sensor captures data on a pixel array of X pixels×Y pixels, where X and Y can vary independently from 40-200. Each sensor 116 can have a defined horizontal field of view (α) depicted by 118 and a diagonal field of view (β) depicted by 120. Each data pixel of the sensor can have an individual field of view depicted by a conical angle θₚ. Every pixel's FoV affects the optimal height of sensor installation h based on the observation that beyond a certain height, projections of neighboring pixels will start overlapping resulting in redundant data across the sensor's pixels equivalent to producing a data artefact of Gaussian blur.

Efforts can be made to reduce or eliminate the Gaussian blur artifacts that lead to false readings per pixel having a high signal to noise ratio (SNR). The installation height h of the sensor 116 is a function of the pixel's conical FoV angle θₚ, the total number of pixels N and the pitch or distribution of pixels within the sensor's sensing element denoted by p. This can be abbreviated as h=g(θₚ, N, p). In preferred embodiments, the function g is estimated per wetness sensor produced in factory.

A lower value of number of pixels N can lead to data being corrupted by Gaussian blurs at each pixel or require a very low height of installation, which may not be practical in most scenarios. However, in cases where the wetness detection sensor is installed at a very low height, such as below basin areas, the number of pixels can be low, though oblique sensor placement may not be possible in such scenarios to reduce SNR.

It is generally desired for the parameter θₚ to have sufficiently large value so that it is not affected by small area patches thereby requiring high sensor placement. On the contrast, a very large value of this parameter will require low sensor placement. Multiple sensor types can be installed within an installation location depending on the availability of sensor placement locations such as false ceilings.

This parameter also governs the smallest patch of fluid area that can be accurately detected by the sensor. In preferred embodiments, the parameter is chosen such that at typical installation heights ranging from 10-12 ft, a patch as small as 1 cm×1 cm can be detected. These small patches are usually detected by a single pixel's activation, when a fluid is present in its FoV. A small degree of overlap between the pixels' FoV on the floor is desired so that in case of one pixel becoming faulty over time, its readings can be compensated and corrected by those resulting from neighboring pixels.

The sensor's placement height h in turn governs the amount of area in cm² or m² that can be monitored by the sensor, or the extent of coverage along X and Y directions. The values of X and Y are a function f of the sensor's height of placement, and its horizontal and diagonal FoV denoted by α and β respectively. This can be abbreviated as X=f₁(α,β,h) and Y=f₂(α,β,h). For each wetness sensor model, the functions f₁ and f₂ are calculated beforehand and appropriate user interfaces provided for stakeholders to view the values for optimal h and resulting X and Y values.

For embodiments where the sensor is installed obliquely instead of the false ceiling, a high SNR is desired so that further regions are not affected by low accuracy values. If such an installation is performed at 10-12 ft from the floor area, the sensor will usually have a high values of N (number of pixels) and greater inter pixel pitch (p) in the pixel array.

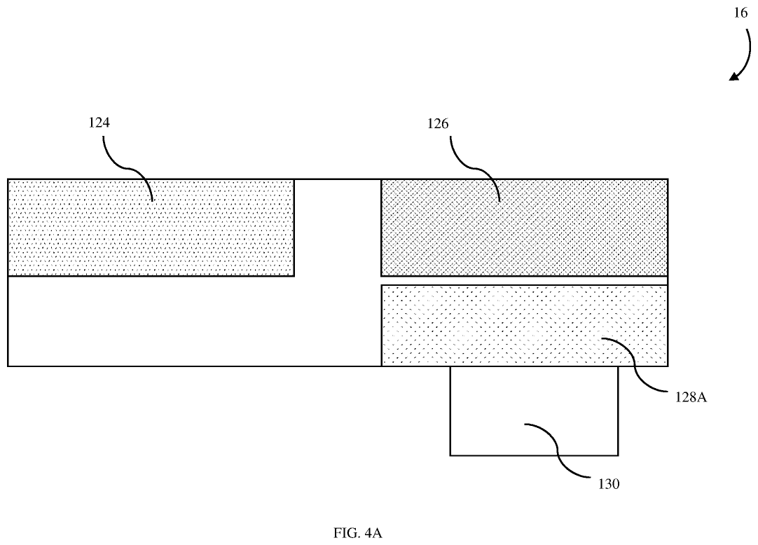

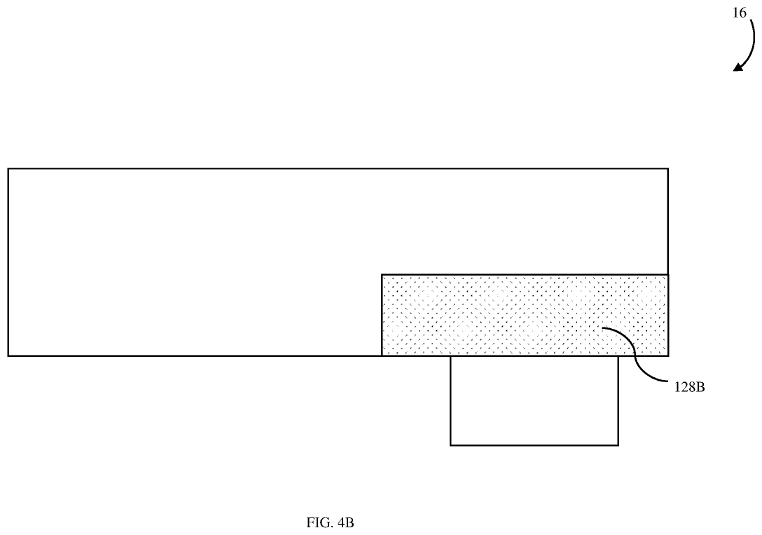

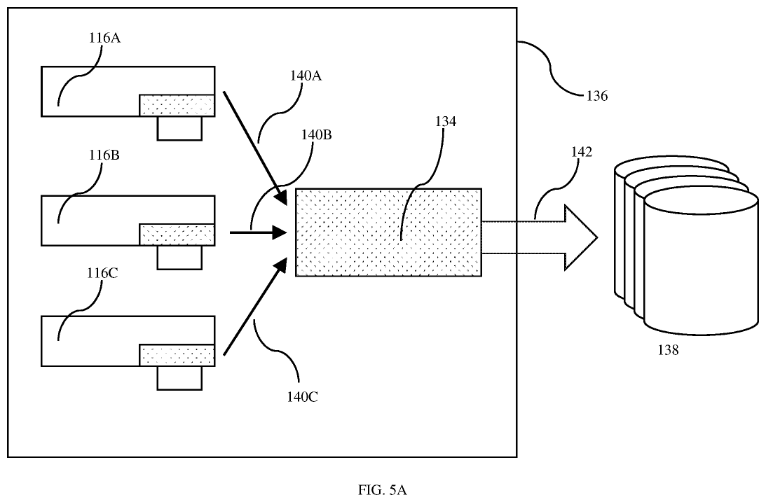

In alternate embodiments, the parameters α,β,θₚ can be artificially modified by using a lens and controlling the aperture or a combination thereof to allow configuration or change when desired. This hardware description is discussed in FIG. 4A and FIG. 4B. By this process, the sensor's hardware specific parameters can be optimally adjusted during installation or further maintenance. FIG. 3B also depicts the field of view of multiple sensors 116A and the effects of height and angle of the area that is monitored for fluid spills.

### Thermal Sensor

FIG. 4A depicts the sensor 116 and its primary hardware components. Each sensor or sensor node is comprised of a sensing element 130, a data interchange unit 128A, a memory unit 126 and a fluid detection unit (FDU) 124. The sensing element houses the thermal sensor along with other components such as lens and window for aperture control. The sensing element overlooks the areas being monitored for fluid detection and collects data. In preferred embodiments, the sensing element 130 is a passively controlled element that responds to heat changes.

In alternate embodiments, an active thermal sensor can utilize both passive heat emitted by various objects in its FoV and heat that is reflected using an active element emitting a wave in some electromagnetic spectrum. This arises from sensor nodes that operate on the principle that certain fluids such as water absorb more electromagnetic radiation in a certain spectrum than other objects such as humans, clothing, ceramics, etc. However, an active thermal sensing strategy can impose higher power requirements on the module and greater points of failure with added complexity of operation. Further, appropriate environmental and health standards must be satisfied by such a sensor utilizing active electromagnetic emission. The advantage of using an active sensor is that the data is segregated into fluid and other materials at the data capture stage allowing further downstream algorithms to detect fluid presence more accurately.

The data interchange unit 128A can transform incoming data from the sensor to appropriate formats (such as after application of transformation matrix or data down sampling around sensor edges). This unit further transmits data to other elements within the sensor node along with a wireless module for communication with the cloud or edge residing gateway.

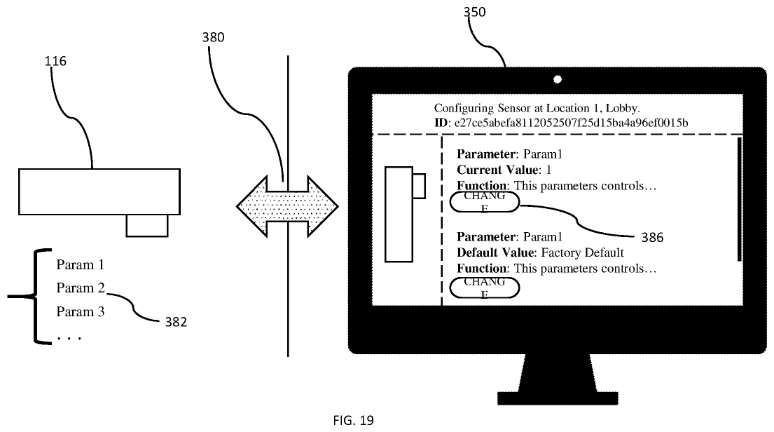

The wireless protocol used can be based on Bluetooth, WiFi or other low power networks (LPWAN) including Sigfox, LORA or narrow band IoT (nb-IoT). The data interchange module can be utilized by other modules to send relevant data such as wetness detection events to the cloud and also facilitate downlink to the sensor node from dashboards and mobile applications to allow parameter tuning in the firmware. Details are further described in FIG. 19.

Each of the modules within the sensor node can communicate within themselves using standard protocols such as I2C, SPI, Serial, and/or other proprietary protocols. This data may be encrypted at appropriate stages for security and reduction in bandwidth consumed during data transfer.

The data interchange module 128A serves filtered data to the memory unit 126. The memory unit implements a buffer where one or multiple sensor data can be stored for consumption by other elements. This can be a FIFO (first in first out) queue that is emptied by processing elements based on a flag setting. An optional garbage collection (GC) module can be utilized that scans the buffer for expiry flags and deletes data at appropriate intervals. In implementations without a GC, downstream processing modules can perform this deletion in a deterministic manner through use of mutual exclusion (Mutex) handles and/or other software methodologies. The buffer can be populated by the data interchange unit at specific intervals (e.g. 1 s, 2 s, etc.) based on the set sampling rate of sensor operation. It is generally desirable for the other downstream processing modules to be able to consume data at a rate greater than or equal to that of the sensor sampling frequency to avoid errors related to buffer overflow and null pointers. In some implementations, a data in the buffer may have an associated time to live (TTL) value following which the data is invalidated and memory pointer set to override the values in a round robin fashion.

The data in memory unit can be compressed using information theoretic techniques to consume least space and allowing easy/fast parsing by downstream consumer modules such as the fluid detection unit (FDU). The buffer can implement appropriate handler functions to allow data read and write access to various modules.

The fluid detection unit (FDU) 124 is the primary module in the sensor node that performs the overall task of fluid detection in the areas being monitored. The data partitioning strategies as described earlier are implemented in this module. The FDU consumes data from the memory buffer at deterministic time intervals and performs appropriate data processing by utilizing associated methods as described in further sections of this description to detect the presence of fluid spills. The FDU also implements methods to identify fluid spill types and the kind of fluid along with their spread. On positive detection of fluid spill by the FDU, it can communicate with the data interchange unit to transmit this information to associated cloud or edge processing algorithms for performing alerting to concerned stakeholders.

In preferred embodiments, FDU operates at an appropriate clock frequency to process data from multiple zones and perform complex mathematical operations including convolutions and matrix multiplications on the data to maintain beliefs about each pixel's detection of a fluid spill and further spatial averaging to identify contiguous areas of fluid spills. To this end, the FDU can implement hardware based sub-modules to allow parallel instruction processing of certain mathematical operations. For example, it can transform each pixel's data through a transfer function and thresholding the output or transformation of a one or two-dimensional data vector through a hash map based lookup table.

FIG. 4B depicts an alternate implementation of the sensor node that operates on an edge processing paradigm. The sensor node comprises the data interchange module 128B that transfers data at the sensor's sampling frequency to (a) a local facility residing gateway or (b) the central cloud platform outside premises. This implementation allows multiple sensors to remove the data processing hardware and utilize a centrally located fluid detection unit that handles data from multiple sensor nodes at their respective sampling frequencies and parameter configurations.

However this approach has shortcomings including (a) failure of wetness detection sensors as a whole if the FDU is not functional or down due to any software or hardware fault and (b) maintenance of persistent data communication links with the FDU requiring data interchange without corruption over network. In this embodiment of spill detection sensors, the data can be encrypted and compressed by the data interchange unit using secret keys or other cryptographic functions and utilities. Other modules such as the memory unit and FDU are implemented by the gateway per sensor to allow independent data processing per node. The gateway processing unit should be appropriately provisioned in terms of memory and computing power to allow a large array of spill detection processes to execute in parallel and the crashes of each process not affecting any other module.

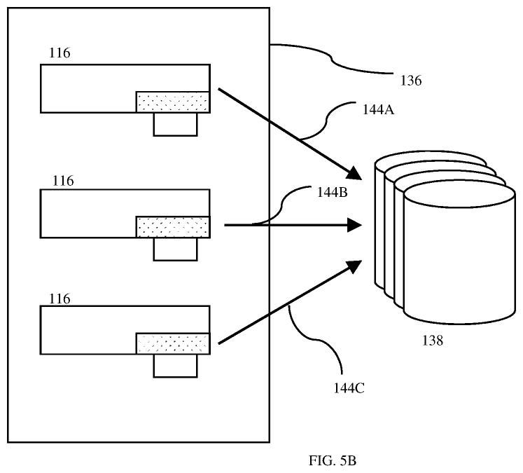

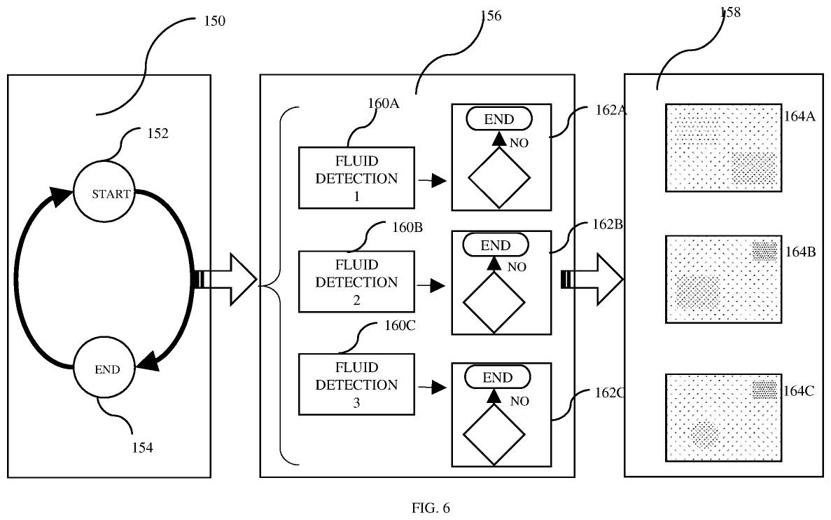

FIG. 5A depicts the data processing pipeline for implementations where multiple spill detection sensor nodes (116) communicate with a locally deployed gateway module 134 to forward data captured for processing and data aggregation at per installation level. The gateway device and the sensors reside within a virtual network of the facility 136 where each sensor node may not have direct access to the internet. However, the gateway module has a persistent connection with the central cloud 138 that hosts elements such as alerting modules, database, dashboards, mobile applications, and/or other associated software entities. The data interchange links between sensor nodes and the local processing gateway are depicted by 140A, 140B, and 140C. Various protocols based on TCP/IP, UDP, and/or others can be implemented by the layer to perform data interchange.

The local gateway 134 can implement either an active pull based or passive push based strategies for accessing data from multiple sensor nodes. In an active pull configuration, the gateway module polls for data from the sensor nodes at defined time intervals. The sensor nodes respond to each poll event by responding with buffered data frames or a false value indicating no data. It is generally desirable to maintain a master sampling frequency on the gateway such that each sensor node has none or at most one data frame per polling request.

In an alternative implementation of this polling strategy, the gateway maintains a list of sensor nodes connected and their individual sampling rates. Following this, a separate process or thread handler periodically executes polling per sensor node to retrieve last data frame and perform processing. The sensor node list can be constructed dynamically by the processing gateway in response to new sensor nodes connecting to the gateway. A sensor node can be deemed faulty if data requests persistently fail or may indicate a network problem if failures happen sporadically across one or more sensor nodes around an installation location. In a polling strategy, the role of each sensor node is to capture data at its sampling frequency and populate the data interchange module with the latest data for retrieval.

The local gateway model can also be based on a passive push based strategy in preferred embodiments. In this operation mode, each sensor connects to the gateway and pushes data at its own respective sampling frequency. The role of gateway device is to perform event-based processing of data frames as they arrive from the sensor nodes. This operation mode obviates the need for running an exclusive timer per sensor node for data retrieval while the downstream data processing strategies may remain largely similar.

The connection link 142 between the gateway device and the cloud platform facilitates data transfer between the two entities. Data can comprise wetness detection events on one or more sensor nodes, or other information associated with parameters and sensor health status. The link can be encrypted and accessible using authenticated protocols before any data interchange can happen over 142. In event of temporary connection loss, the gateway module can implement methods to store data in a buffer with associated timestamps of occurrence and send them in bulk on link restoration.

FIG. 5B depicts a group of sensors. Each sensor is independently connected to the central cloud outside the facility premises. In this operation mode, two kinds of strategies are possible for data processing; on the device nodes or on the cloud. In preferred embodiments, the data is processed on each sensor node and the nodes transmit information to the cloud 138 about wetness detection events and associated metrics such as belief, type of fluid, type of spill, etc.

In alternate implementations of this operation mode, the sensors push data to the cloud at their respective sampling frequencies while the cloud platform is responsible for data aggregation and processing. However, this approach can put stress on the network, especially if the number of pixels N per sensor node and/or their sampling rates are high. In such scenarios, it is generally desirable for the FDU to reside within the sensor nodes. However, in scenarios where the sensor nodes have less number of pixels and their sampling frequencies are less (for example, once every 60 seconds), the data can be compressed and transmitted to the cloud platform for further processing and belief update per pixel. The former method of operation is desired in primary embodiments of the sensor nodes. Communication links 144A, 144B, and 144C are appropriately encrypted between each sensor node and the cloud platform.

FIG. 6, depicts the overall method for wetness detection implemented by the sensor nodes, gateway or the cloud. Three primary sub-processes comprise the overall detection process as depicted by 150 (data capture sub-process), 156 (fluid detection sub-process), and 158 (belief update sub-process). In further sections of this description, various sub-modules within the sub-processes will be elaborated. These modules are a software level breakdown of the wetness detection process and each software process can encapsulate one or more hardware level components as depicted in FIG. 4A and FIG. 4B.

Sub-process 150 captures data through the sensing element and broadly encompasses a continuously looping state machine with start condition denoted by 152 and a termination or end condition denoted by 154. Data from this process is utilized by the fluid detection sub-process 156. This process broadly segregates data into multiple pre-defined zone definitions, ignores data from ignore location specified, and performs the fluid detection process per zone in parallel for each zone as denoted by steps 160A, 160B, and 160C. Finally, at the end of each parallel block in the sub-process, a checker condition is applied that responds “true/yes” if the block resulted in a positive fluid detection in the data.

Lastly, fluid detection triggers from sub-process 156 are transmitted to sub-process 158 that maintains and updates a belief model per pixel. This belief model represents the sensor node's belief about observing a fluid spill in that pixel's FoV as depicted by shaded regions in 164A, 164B, and 164C (larger density implies greater belief and vice versa). The belief model is further utilized to finally determine a sensor node positive detection output containing meta data about its belief, type of spill, kind of fluid that was detected, spread area, criticality, and/or others.

It is noted that one or more blocks within these sub-processes defined can reside and be implemented partially or completely on the gateway compute module or cloud servers depending on sensor operation mode. We now proceed to describe the process flow of various processing blocks of each sub-process in further detail.

### Data Capture

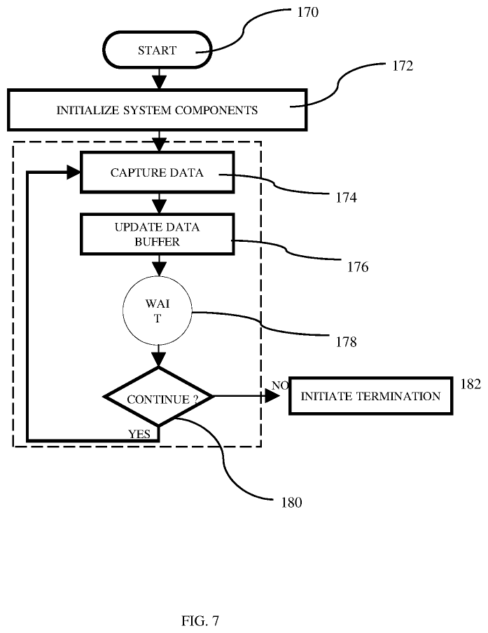

FIG. 7 depicts the data capture sub-process 150. The process can be initiated at step 170 with a start condition. This condition is usually indicated by the sensor node after successful boot-up and/or establishing the wireless connection along with other necessary modules. The start condition can also be set as a result of user specified command requesting firmware restart.

Post start condition at step 170, the sub-process initializes various components at step 172 that are necessary for the wetness detection process. This step can include initialization of the fluid detection unit (FDU) 124, resetting of memory unit 126, resetting of sensing node 130, shutter control, and performing checks about the health status of the sensing node. Health checks about the sensing node can also be performed periodically post step 172 to ensure proper operation. Additionally, a pre-data capture sensor calibration can also be performed in some embodiments to adapt the sensor readings with that of changing ambient conditions including but not limited to temperature and humidity. This sensor calibration step can result in the sensor node generating offset values or scaling values per pixel representing error corrections applied to the data from each pixel. This shift in readings can occur over time due to changing ambient conditions, sensor deterioration with time, and/or other factors related to hardware.

After initialization of system components at step 172, the sub-process enters a data capture loop specified by dotted lines. In further parts of this description, all modules that operated in a time looped manner are depicted enclosed by dotted lines around the respective process blocks. The sub-process performs data capture at step 174 by communicating this intent with the sensing node 130 over relevant communication protocols. In some embodiments, an optional request time can be logged by the step to indicate the timestamp of request. This timestamp is used by downstream modules to maintain a response time log of the sensing node. This online calculation in turn can help in estimating the health of the interface/link between the sensing node and the data capture sub-process. Large latencies in request and response times can indicate an unhealthy link and vice versa.

Every data capture request to the sensing node can result in the node responding by activating the sensing node to log scene data at step 176. The data buffer in the memory unit is populated as a result of this request along with associated time stamp. The position of data to be inserted in the data buffer may be indicated by a memory pointer that operates in a round robin manner to maintain a cyclic array of data points captured. In preferred embodiments, methods are implemented to allow consumption of this buffer in a deterministic time so that there is no latency in data capture and processing pipelines implemented by multiple sub-processes. The buffer may be operated in first in first out (FIFO) or last in first out (LIFO) manner depending on whether each data frame in the buffer needs to be processed or only the last data needs to be processed while ignoring older timestamped data frames. The addition of a new data frame in the memory unit's buffer may be indicated by the sensing node through use of interrupts (or flags) thereby maintaining an asynchronous behavior in the operations of data capture and processing.

In alternate embodiments, the data capture step can be operated synchronously with the data processing pipelines. In this implementation, the data buffer is designed to hold at most one data frame until it is consumed or processed by downstream processing pipelines or sub-processes. Operating in a synchronous paradigm is generally more deterministic as the sensor can be in only one state at a time, as compared to the parallel states of data capture and processing in an asynchronous operation mode.

The sensing node can additionally perform a time based wait or delay operation at step 178 where the sensing node does not accept any commands from the controller for new data capture. This timeout is usually indicative of the amount of time allocated to the downstream processing modules to consume data in the memory unit and update results. The wait time can range from few milli-seconds to many seconds depending on sensor configuration and its mode of operation.

At step 180, the sub-process performs a conditional check on whether it must continue with the data capture loop. This is usually indicated by an interrupt or flag by the system as a result of multiple conditions that may require data capture to be halted. If the continue flag is true, the data capture sub-process continues to step 174 else the termination module is initiated at step 182 causing the END state of the sub-process (154, see FIG. 6) to be activated.

Termination conditions 182 examples could be a result of command for sensor node reboot, sensor fault and/or others. Further, the termination condition can raise interrupts or flags for other sub-processes in the sensor node to indicate unavailability of newer data in the memory unit, that can further result in their termination or wait states.

### Fluid Detection

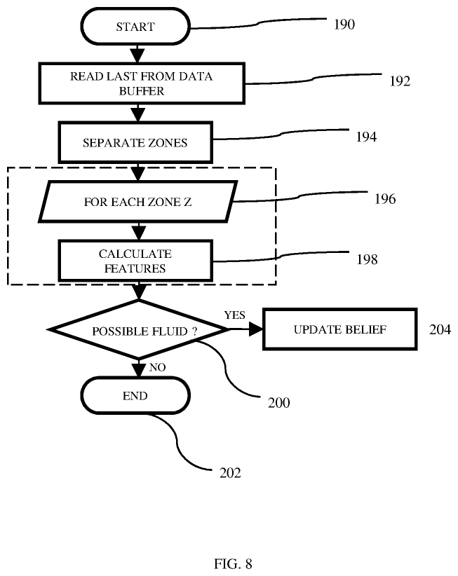

FIG. 8 depicts the process flow for sub-process 156 or the fluid detection sub-process described in FIG. 6. The process starts at step 190 which is triggered if the data capture sub-process is executing normally and no termination interrupts were raised by the data capture sub-process.

The sub-process reads data from the memory unit's data buffer at step 192. Depending on the operation mode of the buffer (FIFO or LIFO) the data may be read in (a) batch collectively followed by an aggregation method or (b) single data frame while discarding older values. A memory pointer is utilized to facilitate data reading from a start location to an end location and another memory pointer indicating the operation mode of the buffer. In case of operation mode (a), the aggregation metric can be based on average of data across each pixel, median, mode, minimum, maximum and/or other custom metrics such as those depending on the overall distribution of data around a neighbourhood of each pixel. The aggregation metric serves the purpose of noise removal and data smoothing. Appropriate parameters for each aggregation function can be utilized to control its smoothing or damping factor on data frames captured. A higher smoothing factor may result in inaccuracies during detection of single or small fluid spills. Likewise, no smoothing may result in grainy data across the pixels of the sensor node resulting in a low SNR per data frame and errors in detection of small fluid patches. Post reading of data from the memory buffer, the step can additionally perform a clear or delete operation through appropriate method interfaces provided by the memory unit. In preferred embodiments, deletion implies memory locations where data can be overridden, thereby not requiring an explicit delete operation.

At step 194, the data frame is further segregated into zones as defined in FIG. 2B by areas 110. Data from each zone is treated separately as if they were captured by different sensor nodes installed above them. Further application of data neglecting masks for regions inside the zones can be performed, for example, removal of constant or static background sources such as cubicles and basins. Zone segregated data can be stored in appropriate locations in contiguous memory blocks, with their start positions and lengths specified in the primary memory address pointer. For each sensor node, a specific maximum number of zone definitions may be possible, depending on the fluid detection unit, and other parameters associated with memory and compute power in case of sensor nodes where data is processed on the device.

Following this data segregation and filtering, the sub-process enters a loop state through step 196 where each zone is processed. This processing can occur in parallel through specialized hardware of the sensor node or synchronously per zone. In each operation node, the time to completion or execution is deterministic, allowing other modules to operate in synchrony. Step 196 takes each zone data by accessing its headers (memory start position and length) and forwards to step 198, where the primary feature extraction occurs for fluid spill detection.

Features at step 198 can be calculated by multiple methods. An example is through application of certain filters on patches or blocks of data that have been designed such that the response for various filter parameters varies by the type of material within the sensor's field of view. For this feature calculation, a prior offline data collection can be performed by the sensor node post installation by collecting data frames representing only background (static objects such as floor, basins, urinals, etc) and those containing various common spill types in defined patches. Finally, the sensor node may utilize a supervised learning module to calculate appropriate parameters for generation of a pre-trained model. This supervised learning module can be a part of the FDU or reside on the gateway device or the cloud platform. The design of these filter banks can be performed after experiments in the real world and the observation of certain thermal features for various fluids that can in part be a result of their specific or latent heat capacities, thereby affecting their interaction with a floor surface when spilled. Moreover, most fluids on a non-sloping surface show aggregation properties due to their surface tension resulting in specific shapes.

Another feature that is utilized by the sensors is through a temporal tracking of each pixel's thermal data with time. A model zoo can be trained on the sensor node, gateway or the cloud servers to indicate characteristic curves for various fluids and background at varying ambient conditions of temperature and humidity. This model zoo can be dynamically applied to the data points from multiple zones for each pixel or a spatial aggregation of pixels.

Additionally, shape based features can also be extracted by the sub-process at step 198. Shape based features usually take into account the curvature of shape subtended by the pixels and/or their central moments. For example, fluids such as water show a greater tendency to appear as circular blobs with multiple side chains representing spills. The side chains may be prominent or absent depending on whether the fluid spill happened due to a drop or leakage event.

Further, the multiplicity of features calculated for each zone can be combined through use of dimensionality reduction techniques that remove correlations between data and reduce the feature vectors to lower dimensions where classification can be performed. Classifications can be performed through use of multiple statistical models including those based on Bayesian methods, graphical methods, methods utilizing neural network architectures, unsupervised clustering based methods, nearest neighbor based methods, regression based methods, or anomaly detection based methods. The association of a multiplicity of features with multiple fluid types is performed by a human in the loop. This feature tagging can be performed by collecting data representing multiple spill scenarios under varying ambient conditions. Because it may not be possible to simulate or perform pre-defined experiments for every possible scenario of fluid spill for multiple spill types, appropriate interpolation techniques can be applied in the feature domain to generate this data synthetically within known or calculated error bounds. Further machine learning methods can be applied to this generated dataset for producing a model zoo, where classification results from multiple models can be utilized to infer the final fluid spill and its type.

In some embodiments, the sensor nodes can actively download the model zoo parameters at pre-defined times of the day to perform on device calculation of features. This approach imposes higher memory and compute resources to be allocated per sensor node while reducing the latency in feature calculation and classification. The loop ends with calculation of features for every zone defined. Feature classification is performed at step 200 by the sub-process where calculated feature vectors through methods described in step 198 are classified and appropriate thresholding performed to generate a binary decision of fluid presence. For example, in case of probabilistic methods, a probability value of greater than 0.5 can be used as the binary threshold. Additionally, metadata associated with criticality calculation (how critical is the fluid spread), spread density estimation, location of spills, and confidence values for fluid presence may also be available through use of certain machine learning models in the model zoo.

If step 200 results in an affirmative decision, the belief update sub-process is invoked with appropriate data through step 204. In case of a negative decision, that is, no classification of any zone resulted in fluid detection output, the sub-process flow is terminated at step 202. Following termination at this step, appropriate model parameters and other relevant metrics can be updated if the sensor node is operating in training mode.

### Belief Update

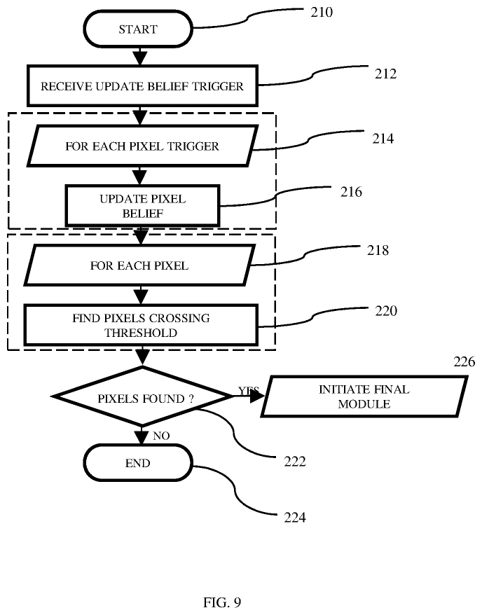

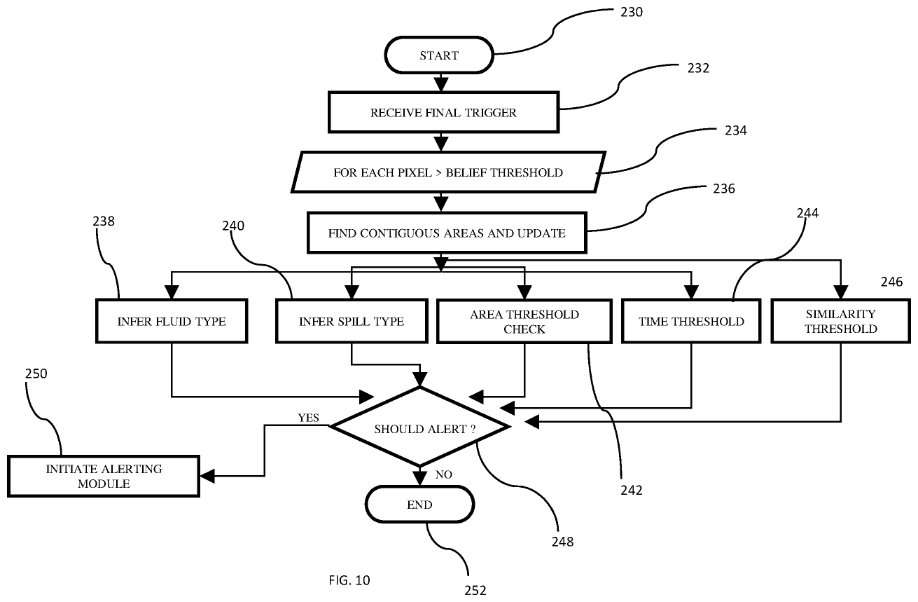

FIG. 9 depicts the process flow of the belief update module 204 described in FIG. 8 that is invoked if a zone resulted in positive fluid detection. The sub-process is initiated at step 210 by the invocation of module 204. This invocation can be implemented as interrupt based or function/procedure call based methodologies by the sensor nodes.

At step 212, the sub-process aggregates the positive detection outputs from multiple zones from the fluid segregation module described in FIG. 8. The term belief represents a value that is indicative for each pixel in the sensor node, whether it is observing a fluid in its FoV or not. Usually, the belief value is designed to be directly proportional with the chance of fluid spill. Belief values can be stored as integers in preferred embodiments or floating point values in alternate embodiments. Update of belief values for every pixel in the thermal sensor implies the change of these belief values within defined ranges using a mathematical function.

At step 214, the sub-process iterates through the detection events from each zone and its respective pixels followed by a belief update at step 216. The operation can be parallelized per zone or performed sequentially. The belief update model may be bounded within pre-defined lower and upper limits by use of bounded mathematical functions such as sigmoid, hyperbolic tangent, thresholding, and/or others.

In another embodiment of the belief update module, this update operation is performed for every pixel in each zone irrespective of positive or negative detection event. A negative detection event results in decrease of belief values and positive detection results in increase of the belief value. In another embodiment, the belief per pixel per zone can be decreased as a function of time with respect to the sensor's sampling rate. This temporal belief update model implies that belief values will keep decreasing according to a mathematical formulation unless reinforced by constant detections for that pixel. These mathematical formulations can be exponential, linear, quadratic, and/or other appropriate metrics as desired.

At step 218, each pixel in the zones are iterated and checked to determine if they are crossing a pre-set threshold at step 220. In case of bounded belief values, this may represent specific values of the function's output. In case of unbounded belief values, any such threshold crossing event may result in resetting of the belief to 0 or its default value state. Step 220 results in an aggregation of all pixels in each zone that are crossing their defined thresholds. These aggregations typically represent clusters of fluid spill on the area being monitored.

A time based adaptive belief threshold per pixel can be utilized that depends on parameters such as time of day, history of belief values observed in past. A dynamic thresholding paradigm is helpful in increasing the sensitivity of the sensor nodes during peak hours or other specific durations.

At step 222, the sub-process checks for a condition if any zone has a set of pixels crossing the belief threshold value. If this conditional check results in a negative response, that is, no pixels crossing the belief threshold, the sub-process terminates at step 224 and appropriate handlers invoked for clearing memory space for a clean exit. If the conditional check results in an affirmative response, the final or the type inferring sub-process module is instantiated at step 226 through interrupts or procedure calls. This module is the last sub-process for the belief update sub-process depicted by 158 in FIG. 6.

### Determining the Type of Fluid

FIG. 10, depicts the type inference module. This module receives initiation trigger from the sub-module shown in FIG. 9 through 226 and performs self-initialization at step 230. The self-initialization step involves provisioning of appropriate memory and their interfaces for utilization by further processes in the type inference module.

At step 232, the module aggregates all triggers from the process flow described in FIG. 9 through interface step 226. Aggregation of triggers is indicative of regions within various zones that contain fluid spills with high possibility. The type inference module described here is responsible for spatial and time based aggregation of pixels representing fluid spills. Spatial aggregation helps in noise removal and generating estimates of size of spills. Time based aggregations can be indicative of the amount of fluid spill and how long they have been present in the installation location thereby making them more critical to be addressed.

At step 234, the sub-process starts an iteration over each pixel and/or their immediate 4, 6, 8, 10 neighborhood to find contiguous blobs or regions of pixels over the sensor's pixel array. In some embodiments, image stitching across multiple connected zones can also be performed by 236 to generate an estimate of spatial continuity of the fluid spill. For example, water can spill over a basin vanity top area defined within zone 1 towards the edge of floor area defined within zone 2. At step 236, a list of blobs is obtained that can be as small as one pixel (resulting from small drops approximately 1 cm×1 cm in area). Following this step multiple parallel checks are performed by the sub-process that are configurable partially by stakeholders through user interfaces provided.

Process flow 238 is the module for inferring fluid type. This module results in probabilistic output of the fluid type observed by the sensor node such as hot beverage, cold beverage, water, urine, and/or other relevant categories. These categories can be defined according to a general collection instead of very specific types. Further, the categories can be based not only on their content but also on other parameters such as their temperature and/or others.

Process flow 240 is utilized for inferring the spill types. Spills can be categorized into classes such as: multiple small spills, large fluid spill or a combination. Spill type and fluid type information is helpful for stakeholders in determining the equipment that needs to be carried for handling the wetness detected for that installation location. For example, a big spill of a hot beverage may need different cleaning equipment than multiple small spots of water dropped by people washing hands in basin areas. Further, a spill type or fluid type may be more critical in certain installation location such as hospital lobby or mall general area than inside a washroom of a less used area.

The area threshold check at step 242 is responsible for removal of blobs or regions that do not satisfy the minimum criterion for alerting. For example, some installation locations may not require alerting based on presence of fluid spills smaller than 1 cm×1 cm or likewise.

The time threshold check implemented by step 244 is responsible for maintaining a log of last detection times for each zone and blocking any other detections from resulting in an alert if they happen within a threshold duration. For instance, if the presence of fluid was detected on vanity top area inside an installation location at 11:00 AM, no further activations might be desired till 11:30 AM.

Finally, a similarity threshold process flow is implemented at step 246 which is responsible for generating a similarity value between current detection and past few detections for every zone defined within the sensor node. This value is utilized in blocking a detection event if its similarity with that of past events is high, implying that the same area is still unclean. For example, a similarity value of more than 60% may imply that the same region is generating detection events and generation of constant alerts from this region is not desired. The details of each parallel process flow described above has been provided in later sections of this environment.

All metrics are integrated by a conditional check module at step 248 that generates a binary decision indicating that an alert should be generated or not. In an affirmative response, the alerting module is activated through interface 250 that is responsible for finding the stakeholders associated with a sensor node's results and alerting them on their mediums. In a negative case, the process flow ends at step 252.

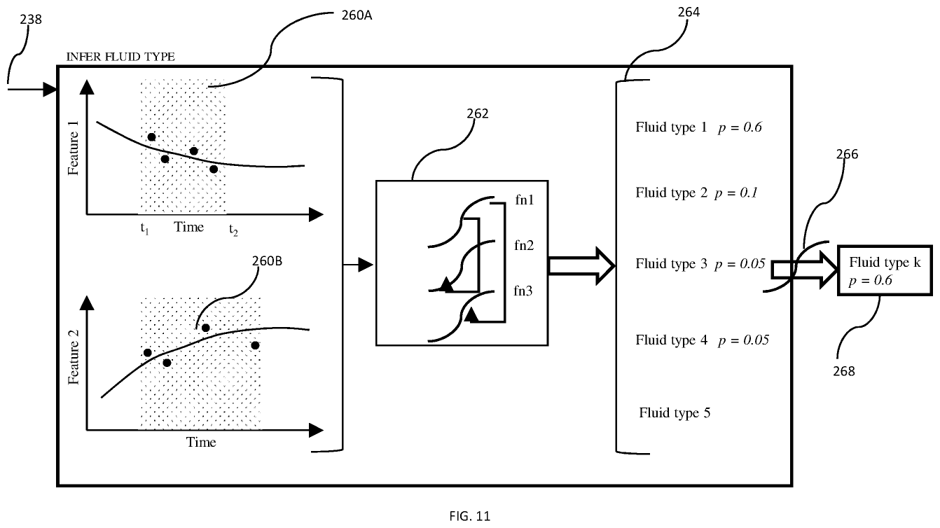

FIG. 11 depicts the procedure to identify fluid type (238). As described earlier, the aim of this unit is to identify fluid types such as hot beverage, cold beverage, cold water, water, etc. The module extracts various spatial and temporal features associated with each aggregation calculated in step 236. Multiple features can be extracted as described earlier, such as those related to filtering, temperature gradient, and/or others. By utilizing the pre-trained model zoo available on the edge gateway or the cloud platform, sensing nodes can perform feature classification through step 262. Step 262 represents the machine learning model applied to the data points or the feature vectors.

A typical machine learning model in step 262 can result in a probabilistic indication for various categories to be classified as depicted by 264. Dimensionality reduction and/or data averaging or filtering can be performed on the feature vectors prior to using them in the machine learning models. A multiplicity of machine learning models can be applied simultaneously on the feature vectors to obtain a list of predictions for each class.

Step 266 represents a transfer function applied to the probabilistic output from the model zoo per category (Cᵢ) per aggregation area (Aⱼ). A vector of probabilities is represented as p_{C}_{ᵢ}^{A}^{ⱼ}=[p₁,p₂,p₃, . . . ,pₖ],Σ^{k}pᵢ=1, where k is the number of models applied at step 262 by the sensor node. The transfer function takes input as vectors represented by p_{C}_{ᵢ}^{A}^{ⱼ} and outputs a single unique value per area, O^{A}^{ⱼ} by applying functions such as average, median, maximum, minimum, log of sum, exponential sum, weighted average, and/or others. A transfer function can be abbreviated as O^{A}^{ⱼ}=f_{∀ C}_{ᵢ}(p_{C}_{ᵢ}^{A}^{ⱼ}), that performs a normalization over each category.

It is noted that the transfer function is also responsible for calculation of one category per aggregation area representing the sensor node's belief about the fluid type. The transfer function's output 266 is the output of this module represented by 268. This is a vector of values (each value being in range [0, 1]) of length equal to the number of aggregation areas found earlier.

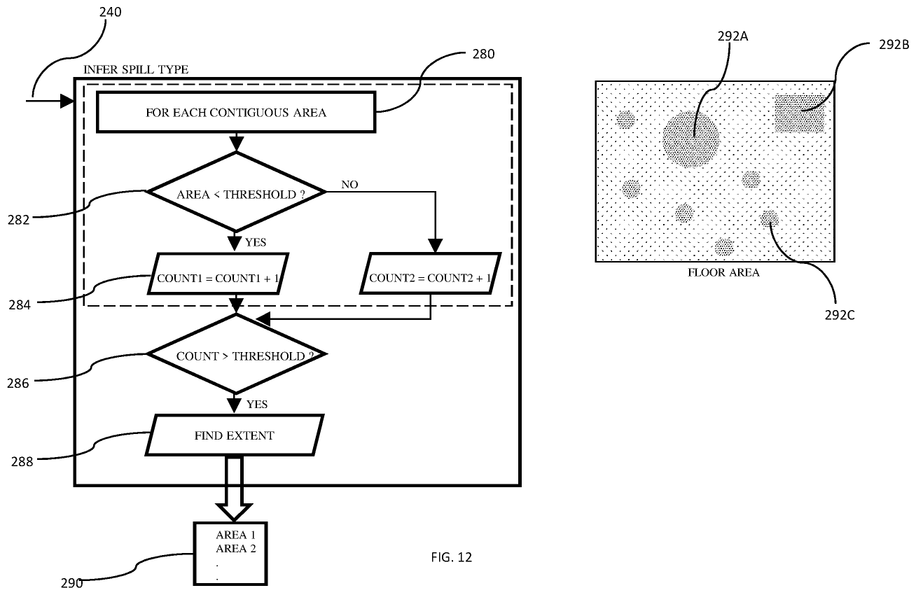

FIG. 12 depicts a procedure for identifying the spill type in various zones (240). The process starts at step 280 by aggregating various spill areas through 236 in various zones. For each such contiguous area Aᵢ found in a zone, a conditional check is performed at step 282 to check if the area in pixels is less than a pre-defined threshold. The threshold τ depends on factors such as sensor node's pixel array count N, height of sensor node installation h, mode of sensor installation (oblique or downward facing), and/or other user defined values.

Step 282 is useful in segregating smaller areas from larger areas or smaller spill types from larger spill types. The area check results in an update to two types of counters, one each representing the number of small spill type areas and that representing the bigger spill type. This counter update operation is performed at step 284 resulting in updates to COUNT1 or COUNT2.

Finally, after evaluation of this thresholding operation for each aggregation area for each zone, an overall check for their counts is performed at step 286 to infer the number of areas representing the two spill types. The conditional check at 286 is utilized to filter areas with less number of areas detected.

For example, it may be desired to consider areas of type small spill only when they span a count greater than a threshold (this may in turn translate to a physical manifestation of the number of small drops on the area being monitored). Likewise, for larger spill types, the count threshold may be lesser, as bigger blobs contribute more to an unclean location as compared with smaller blobs or areas.

If the result of step 286 is true, the extent of spread and other associated parameters are calculated at step 288. This step results in generation of metadata about the spill type that can be utilized by downstream modules in deciding the content of alerts or notifications being sent out.

The output of this module is represented by 290 that contains information about the various areas and their spill types. Some examples of various spill types are depicted by 292A (bigger spill size), 292B (smaller spill types), and 292C (false positive resulting from sources such as wet tissue on the floor).

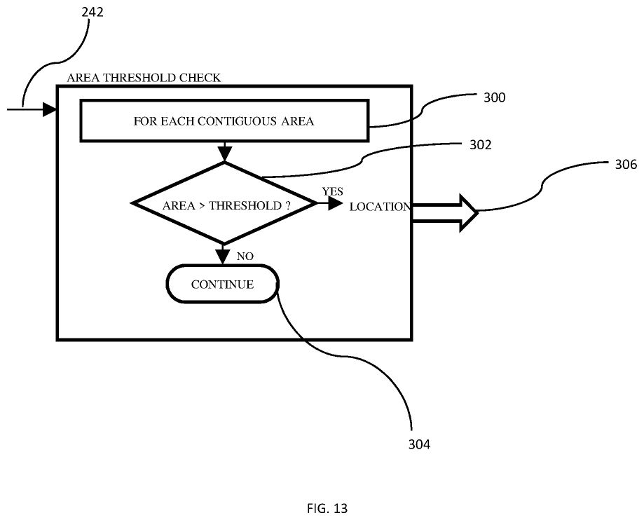

FIG. 13 depicts the area threshold check module 242. The area threshold check can be performed for contiguous areas found in various zones. This parameter checks the total area subtended by a blob or spill on the surface. Additionally, only those areas resulting in negative response to step 282 in the spill type module can be utilized for evaluating area checks.

The process flow starts at step 300 by iterating over each such area for each zone and performing a conditional check at step 302 resulting in a true or false response. In case of a negative evaluation response, the process flow ends at step 304. In case of a positive evaluation response, the location is added to the output vector as the module's response parameter, specified by 306.

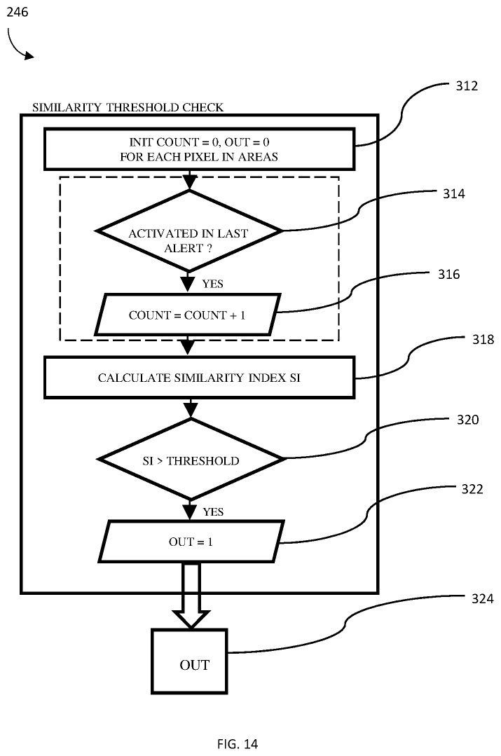

FIG. 14 depicts the similarity checking module 246. This module calculates a similarity index for various areas detected in each zone. The process starts at step 312 by initialization of internal parameters COUNT and OUT to 0 for each pixel location in a contiguous area. The parameter COUNT indicates how many times the same pixel location was activated in the last alert. The parameter OUT is binary value indicating high or low similarity (1 or 0 respectively).

After initialization at 312, the process loops over each pixel in step 314 and performs a conditional check of whether it was activated in the last alert or activation. If the result is true, the COUNT value for that pixel is increased by one through step 316. After completion of this iteration, each of the N pixels in the sensor node's array will have values greater than equal to 0, indicating the activations in past. Note that an activation implies a complete detection event where belief must be updated, threshold crossed and an alert generated after passing each of the modules such as type, area, time and similarity.

After looping through the pixels of each zone, the process calculates a similarity index (SI) value. It is desired for the similarity index to output higher values if the similarity between current spill areas and past spill areas detected is higher. Additionally, the SI value may be bounded in certain range such as [0, 100], where 100 indicates exact similarity and 0 indicates no similarity.

The SI value is calculated per zone per spill type aggregation. For example, an alert might be generated by a spill in some area and result in reactivation after some time if the area was not cleaned. In some cases, the fluid shows a behaviour of drying up that may reduce the effective area of wetness. An alternate implementation may utilize an additional convexity value to perform a shape matching and/or fluid type matching to contribute towards the SI indicating that the spill detected currently is the same as past.

In some implementations, a timeout parameter may be utilized that controls the effect of SI with respect the time of last alert triggered, for regions with high similarity. Overall, the SI metric function for each aggregated area can be represented as a function of last alert time, last fluid type, convexity of current area, pixel ratio of overlap, and/or others.

At step 320, a conditional check is performed to indicate if the current SI value for each area is greater than a pre-defined threshold. The threshold is chosen based on the bounds of the SI metric function. For instance, in case of [0, 100], the threshold may be chosen as 60.

If the result of step 320 is true, the value of OUT for that area is set to be 1 (indicating high similarity) at step 322 else the value remains unchanged from 0. The output of the process is finally taken as the binary value of parameter OUT for each aggregation area for each zone. An additional step may be performed post process 246 where regions with high similarity are ignored. Also, the similarity module is usually the first module to execute amongst 238, 240, 242 and 244. This is because the process results in a data filtering operation that is utilized for further calculations.

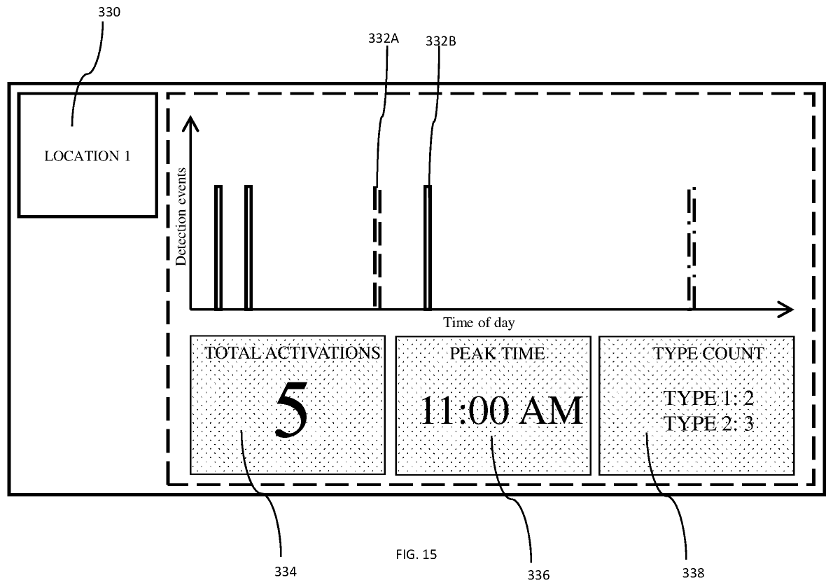

FIG. 15 depicts a sample dashboard example view for the data sent out by each wetness sensor node deployed at various locations within multiple facilities. This dashboard may be a web based HTML page, a static application interacting with the internet installed on the user's computing devices, or a mobile application running on user's phones. Block 330 represents the sensor details such as installation location details, id, and/or others. The data from each node is also shown as a time series graph where data may depict various spill types, fluid types through various visualization types as depicted by 332A and 332B. Additional meta data about each activation may also be presented on the dashboard indicating spill type, amount of spread, optional data view.

A summary for customizable time periods such as day, weekly, etc. can also be presented indicating the total number of activations through block 334, peak times when maximum activations were generated in block 336, and/or a count of the various fluid types detected or types of spill detected at block 338.

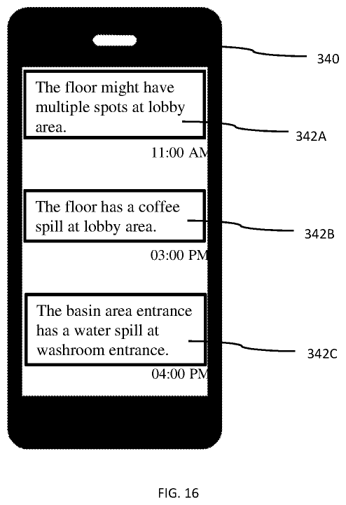

FIG. 16 shows some sample mobile 340 application alerts that can be delivered through mediums including but not limited to SMS and notifications. Alerts can contain descriptive text specifying issues related to wetness of various types such as those presented by 342A, 342B, and 342C.

FIG. 17 depicts a sample computer application 350 utilized for defining zones by any sensor node through a wireless link 354. The user interface can show a data view 358 of the sensor node being configured for the user to draw rectangular zones depicted by 360A and 360B and edit/delete them using tools in 352 and 356. These changes to a sensor node can be sent in bulk on submitting at step 362 or cancelled at step 364. Multiple other alternate strategies can be implemented by each sensor node to receive the changes at any time through multiple protocol definitions.

FIG. 18 depicts the use of an auxiliary device 370 for estimating the area being covered by a sensor node 116. This auxiliary device can be pre-configured and calibrated with the sensor node's FoV such that it can indicate its coverage area through visual indicators depicted by 372. This device can be utilized prior to fixing the sensor node on the false ceiling or other relevant installation material so that an accurate positioning can be performed for wetness detection by the sensor. This process can help eliminate positional error during sensor installation such that areas with static elements or other areas to ignore are not within its FoV. Post estimation of sensor position, the auxiliary device can be removed for further usage with other nodes.

FIG. 19 depicts an interface provided to users through web, standalone or mobile applications 350 for allowing change of various parameters used by the methods in each sensor node. This tweaking can be necessary for fine tuning a sensor node's performance for the given area. For example, a sensor node operating on vanity top can have different parameters as compared to that when operating on floor area, thereby rendering the factory default parameters irrelevant or in optimal. Additional tools may be provided in the user interface to guide the users in parameter selection through a pre-configured list of use cases and their description as shown in 386. A sensor node 116 can have multiple parameters such as those depicted by 382, controlling various aspects of the detection process. This change can be relayed to the sensor nodes through the wireless communication link and middleware interface depicted by 380. This interface can implement system and methods where changes to parameters are pushed to the sensor nodes as they come online and are ready for data reception.

In an alternate embodiment, a sensor node can periodically check the server for parameter change events through a database entry. In this pull based methodology, when the parameter change flag is found to be true, further procedures can be executed by the sensor node to retrieve the new parameters and update itself.

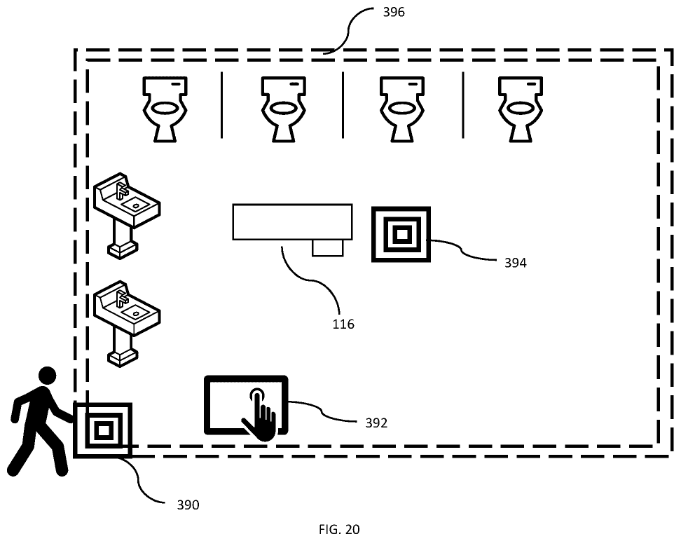

FIG. 20 depicts a typical installation of the wetness sensor node inside a smart washroom location 396 within a facility. Other sensors can be installed in the location such as people density estimation 390, a feedback module 392 and/or an air quality sensor node 394. The presence of a multiplicity of sensors to monitor various parameters of uncleanliness in the location results in a smart washroom where issues are detected and resolved through use of sensors.

### Operating Environment:

The system is typically comprised of a central server (residing on premise server or on cloud or both), that is connected by a data network to a user's computer. The central server can be comprised of one or more computers connected to one or more mass storage devices. The precise architecture of the central server does not limit the claimed invention. Further, the user's computer can be a laptop or desktop type of personal computer. It can also be a cell phone, smart phone or other handheld device, including a tablet. The precise form factor of the user's computer does not limit the claimed invention. Examples of well-known computing systems, environments, and/or configurations that may be suitable for use with the invention include, but are not limited to, personal computers, server computers, hand held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. In one embodiment, the user's computer is omitted, and instead a separate computing functionality provided that works with the central server. In this case, a user would log into the server from another computer and access the system through a user environment.

The user environment can be housed in the central server or operatively connected to it. Further, the user can receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention can be performed on the user's computer and interim results transmitted to a server. These interim results can be processed at the server and final results passed back to the user.

The methods described herein can be executed on a computer system, generally comprised of a central processing unit (CPU) that is operatively connected to a memory device, data input and output circuitry (I/O) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory can be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The I/O devices can include a display screen, loudspeakers, microphone and a movable mouse that indicate to the computer the relative location of a cursor position on the display and one or more buttons that can be actuated to indicate a command.

The computer can display on the display screen operatively connected to the I/O circuitry the appearance of a user interface. Various shapes, text and other graphical forms are displayed on the screen as a result of the computer generating data that causes the pixels comprising the display screen customer's actuation of the browser user interface. Some steps of the invention can be performed on the user's computer and interim results transmitted to a server. These interim results can be processed at the server and final results passed back to the user.

The invention can also be entirely executed on one or more servers. A server can be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server can be partitioned and accomplished on multiple servers that are operatively connected by a computer network by means of appropriate inter process communication. In addition, the access of the web services can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application. The precise architecture of the central server does not limit the claimed invention. In addition, the data network can operate with several levels, such that the user's computer is connected through a fire wall to one server, which routes communications to another server that executes the disclosed methods.

Computer program logic implementing all or part of the functionality previously described herein can be embodied in various forms, including, but in no way limited to, a source code form, a computer executable form, and various intermediate forms (e.g., forms generated by an assembler, compiler, linker, or locator.) Source code can include a series of computer program instructions implemented in any of various programming languages (e.g., an object code, an assembly language, or a high-level language such as C, C++, C#, Action Script, PHP, EcmaScript, JavaScript, JAVA, or 5 HTML) for use with various operating systems or operating environments. The source code can define and use various data structures and communication messages. The source code can be in a computer executable form (e.g., via an interpreter), or the source code can be converted (e.g., via a translator, assembler, or compiler) into a computer executable form.

The invention can be described in the general context of computer-executable instructions, such as program modules, being executed by a computer. Generally, program modules include routines, programs, objects, components, data structures, etc., that perform particular tasks or implement particular abstract data types. The computer program and data can be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data can be fixed in any form in a signal that is transmittable to a computer using any of various communication technologies, including, but in no way limited to, analog technologies, digital technologies, optical technologies, wireless technologies, networking technologies, and internetworking technologies. The computer program and data can be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention can, if desired, be implemented in ROM (read-only memory) form. The software components can, generally, be implemented in hardware, if desired, using conventional techniques.

The invention can also be practiced in distributed computing environments where tasks are performed by remote processing devices that are linked through a communications network. In a distributed computing environment, program modules can be located in both local and remote computer storage media including memory storage devices. Practitioners of ordinary skill will recognize that the invention can be executed on one or more computer processors that are linked using a data network, including, for example, the Internet. In another embodiment, different steps of the process can be executed by one or more computers and storage devices geographically separated but connected by a data network in a manner so that they operate together to execute the process steps. In one embodiment, a user's computer can run an application that causes the user's computer to transmit a stream of one or more data packets across a data network to a second computer, referred to here as a server. The server, in turn, can be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database can be housed in one or more operatively connected servers operatively connected to computer memory, for example, disk drives. In yet another embodiment, the initialization of the relational database can be prepared on the set of servers and the interaction with the user's computer occur at a different place in the overall process.

It should be noted that the flow diagrams are used herein to demonstrate various aspects of the invention, and should not be construed to limit the invention to any particular logic flow or logic implementation. The described logic can be partitioned into different logic blocks (e.g., programs, modules, functions, or subroutines) without changing the overall results or otherwise departing from the true scope of the invention. Oftentimes, logic elements can be added, modified, omitted, performed in a different order, or implemented using different logic constructs (e.g., logic gates, looping primitives, conditional logic, and other logic constructs) without changing the overall results or otherwise departing from the true scope of the invention.

It will be appreciated that variations of the above disclosed and other features and functions, or alternatives thereof, can be combined into other systems or applications. Also, various unforeseen or unanticipated alternatives, modifications, variations or improvements therein can be subsequently made by those skilled in the art which are also intended to be encompassed by the following claims.

Although embodiments of the current disclosure have been described comprehensively, in considerable detail to cover the possible aspects, those skilled in the art would recognize that other versions of the disclosure are also possible.

1. A system for detecting wetness on a surface comprised of:
a) at least one sensor for detecting surface temperatures, wherein each sensor partitions the surface into multiple non-overlapping zones of pixels, wherein sensing parameters in each zone are independently modified, wherein the at least one sensor comprises a memory unit and fluid detection unit, wherein the at least one sensor is installed on one or more walls and/or ceilings;
b) a database for storing surface temperature data;
c) an interface; and
d) a processor comprising a data capture module, a fluid detection module and a belief update module;
wherein the processor identifies baseline temperatures of surfaces in each zone;
wherein the fluid detection module identifies wetness as aberrations from baseline temperatures of surfaces in each zone;
wherein the fluid detection module reads a data buffer from the memory unit and segregates data for each zone, wherein features are calculated for each zone, wherein the features comprise a temporal tracking of each pixel's thermal data over time;
wherein the belief update module aggregates all pixels in each zone that are crossing a belief threshold value to result in a positive wetness detection;
wherein a fluid type inference, a spill type inference, an area threshold check, a time threshold check and similarity threshold is performed on the detected wetness to indicate if an alert is to be generated; and
wherein the processor schedules cleaning and/or maintenance based upon the generation of the alert when wetness on the surface reaches or exceeds a threshold level.

2. The system of claim 1, wherein the at least one sensor is a thermal sensor or thermopile array that records thermal images of the surface of the facility.

3. The system of claim 1, wherein the at least one sensor has sampling rates that are time based and/or event based.

4. The system of claim 1, wherein the at least one sensor further comprises a sensing element and a data interchange unit.

5. The system of claim 1, wherein the at least one sensor has sampling rates that are adjusted based on patterns of facility use.

6. The system of claim 1, wherein the surface is a floor, shelf, table top, sink, panel, appliance top or counter top.

7. The system of claim 1, wherein thermal characteristics of wetness are detected by the at least one sensor; and
wherein the processor identifies fluid comprising the wetness and/or a source of wetness based on the thermal characteristics.

8. The system of claim 1, wherein the surface is in a facility, wherein the facility is a washroom, kitchen, lounge, dining area, conference center, auditorium, gym, recreational area, market, shop, elevator/lift, interior of a vehicle or other gathering area.

9. A computer implemented method for detecting wetness on a surface comprising of steps of:
a) collecting data on surface temperatures using at least one sensor, wherein each sensor partitions the surface into multiple non-overlapping zones of pixels, wherein sensing parameters in each zone are independently modified, wherein the at least one sensor comprises a memory unit and fluid detection unit, wherein the at least one sensor is installed on one or more walls and/or ceilings;
b) identifying baseline surface temperatures in each zone with a processor comprising a data capture module, a fluid detection module and a belief update module, wherein the fluid detection module reads a data buffer from the memory unit and segregates data for each zone, wherein features are calculated for each zone, wherein the features comprise a temporal tracking of each pixel's thermal data over time;
c) identifying wetness as aberrations of baseline surface temperatures in each zone, wherein the belief update module aggregates all pixels in each zone that are crossing a belief threshold value to result in a positive wetness detection; wherein a fluid type inference, a spill type inference, an area threshold check, a time threshold check and similarity threshold is performed on the detected wetness to indicate if an alert is to be generated;
d) comparing data on wetness from at least two time points to improve belief; and
e) alerting one or more workers and/or stakeholders when wetness on the surface reaches or exceeds a threshold level.

10. The method of claim 9, wherein the at least one sensor is a thermal sensor or thermopile array that records thermal images of the floor or surface of the facility.

11. The method of claim 9, wherein the step of collecting data on surface temperatures from at least one sensor has sampling rates that are time based and/or event based.

12. The method of claim 9, wherein the step of identifying wetness as aberrations of baseline surface temperatures accounts for variables including heat from the environment such as sunlight and wind, human body heat, heat from electrical sources and/or heat from light sources.

13. A computer implemented method for identifying fluid in wetness on a floor or surface comprising of steps of:
a) collecting data on thermal characteristics of wetness using at least one sensor, wherein each sensor partitions the floor or surface into multiple non-overlapping zones of pixels, wherein sensing parameters in each zone are independently modified, wherein the at least one sensor comprises a memory unit and fluid detection unit, wherein the at least one sensor is installed on one or more walls and/or ceilings;
b) compiling a database of thermal signatures of fluids based on thermal properties exhibited on one or more surfaces;
c) identifying fluids in each zone by comparing thermal signatures of known fluids in the database, wherein a fluid detection module in a processor reads a data buffer from the memory unit and segregates data for each zone, wherein features are calculated for each zone, wherein the features comprise a temporal tracking of each pixel's thermal data over time, wherein a belief update module in the processor aggregates all pixels in each zone that are crossing a belief threshold value to result in a positive wetness detection; wherein a fluid type inference, a spill type inference, an area threshold check, a time threshold check and similarity threshold is performed on the detected wetness to indicate if an alert is to be generated;
d) comparing wetness detection results from at least two time points to improve belief; and
e) alerting one or more workers and/or stakeholders with information on the fluid.

14. The method of claim 13, wherein the step of identifying fluids by comparing thermal signatures of known fluids in the database accounts for variables including heat from the environment such as sunlight and wind, human body heat, heat from electrical sources and/or heat from light sources.

15. The method of claim 13, wherein an algorithm is used in the step of identifying fluids by comparing thermal signatures of known fluids in the database,
wherein the algorithm uses frequency domain techniques, time domain techniques or a hybrid approach.

16. The method of claim 13, wherein the step of identifying fluids by comparing thermal signatures of known fluids in the database further comprises a step of learning and maintaining an estimate of trends.

17. The method of claim 13, further comprising a step of maintaining a historical record of data.

18. The method of claim 13, further comprising a step of activating one or more autonomous or self-cleaning systems based on an identified fluid.

19. (canceled)

20. The method of claim 13, including a step of segregating a field of view of the at least one sensor into contiguous areas of thermal properties using a continuity criterion of baseline temperatures.

21. The method of claim 9, including a step of segregating a field of view of the at least one sensor into contiguous areas of thermal properties using a continuity criterion of baseline temperatures.
